(19) United States
(12) Patent Application Publication
(10) Pub. No.: US 2026/0089668 A1
(43) Pub. Date: Mar. 26, 2026

(54) MULTI-ACCESS POINT COORDINATION FOR STATION TRANSFER

(71) Applicant: Ofinno, LLC, Reston, VA (US)

(72) Inventors: Jiayi Zhang, Rockville, MD (US); Leonardo Alisasis Lanante, Reston, VA (US); Esmael Hejazi Dinan, McLean, VA (US); Jeongki Kim, Fairfax, VA (US)

(73) Assignee: Ofinno, LLC, Reston, VA (US)

(21) Appl. No.: 19/407,342

(22) Filed: Dec. 3, 2025

Related U.S. Application Data
(63) Continuation of application No. PCT/US2024/033757, filed on Jun. 13, 2024.
(60) Provisional application No. 63/472,850, filed on Jun. 14, 2023.

(51) Int. Cl. H04W 60/04; H04W 60/06; H04W 80/02

(52) U.S. Cl. CPC H04W 60/04; H04W 60/06; H04W 80/02

(57) ABSTRACT

An access point (AP) receives from an overlapping basic service set (OBSS) AP, where the AP and the OBSS AP form a multi-AP group, a first frame: indicating disassociation of a station (STA) by the OBSS AP; and requesting association of the STA with the AP. Based on receiving the first frame, the AP transmits to the STA a second frame indicating association of the STA with the AP.

### CROSS-REFERENCE TO RELATED APPLICATIONS

This application is a continuation of International Application No. PCT/US2024/033757, filed Jun. 13, 2024, which claims the benefit of U.S. Provisional Application No. 63/472,850, filed Jun. 14, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example management frame which may be used as an action frame.

FIG. 5 illustrates an example control frame which may be used as a trigger frame.

FIG. 6 illustrates an example dataframe which may be used as a Quality of Service (QoS) null frame.

FIG. 7 illustrates an example format of a physical layer (PHY) protocol data unit (PPDU).

FIG. 8 illustrates an example multi-AP network.

FIG. 9 illustrates an example network that includes a coordinated AP set.

FIG. 10 illustrates an example multi-AP operation procedure.

FIG. 11 illustrates an example multi-AP sounding phase.

FIG. 12 illustrates an example multi-AP downlink data transmission phase.

FIG. 13 illustrates an example multi-AP uplink data transmission phase.

FIG. 14 is an example that illustrates an existing STA (re)association procedure.

FIG. 15 is an example that illustrates a multi-AP coordinated STA transfer according to an embodiment.

FIG. 16 is an example that illustrates a multi-AP coordinated STA transfer according to an embodiment.

FIG. 17 illustrates an example management frame which may be used according to embodiments.

FIG. 18 illustrates an example action frame which may be used according to embodiments.

FIG. 19 illustrates an example process according to an embodiment of the present disclosure.

FIG. 20 illustrates an example process according to an embodiment of the present disclosure.

FIG. 21 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”.

The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs).

Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

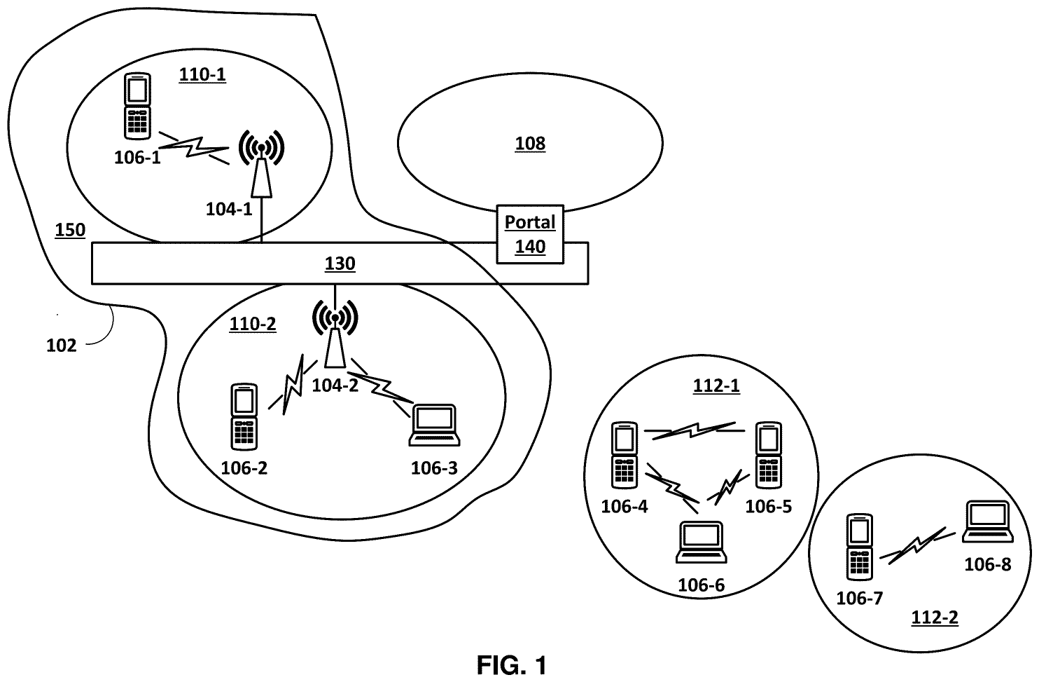

FIG. 1 illustrates example wireless communication networks 100 in which embodiments of the present disclosure may be implemented.

As shown in FIG. 1, the example wireless communication networks 100 may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STA 106-2 and STA 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, AP 104-1 and AP 104-2 are connected via DS 130and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STA 106-4, STA 106-5, and 106-6 may be configured to form a first IBSS 112-1. Similarly, STA 106-7 and STA 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 1120 MHz by bonding together multiple 20 MHz channels.

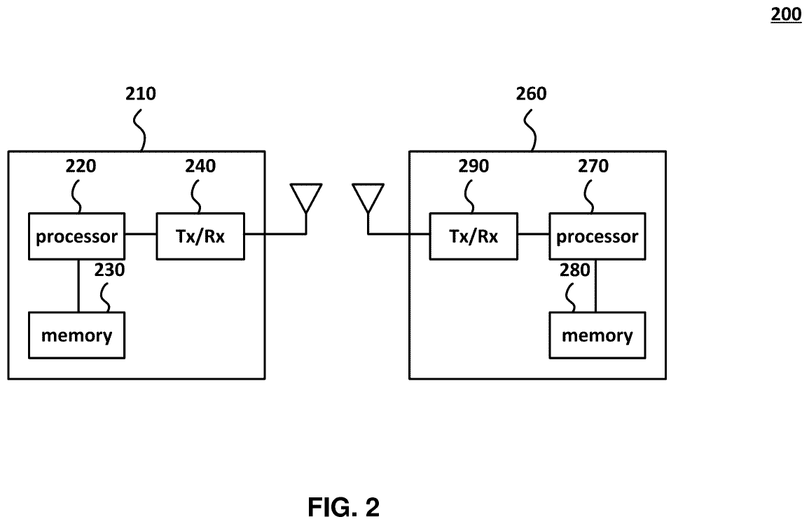

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

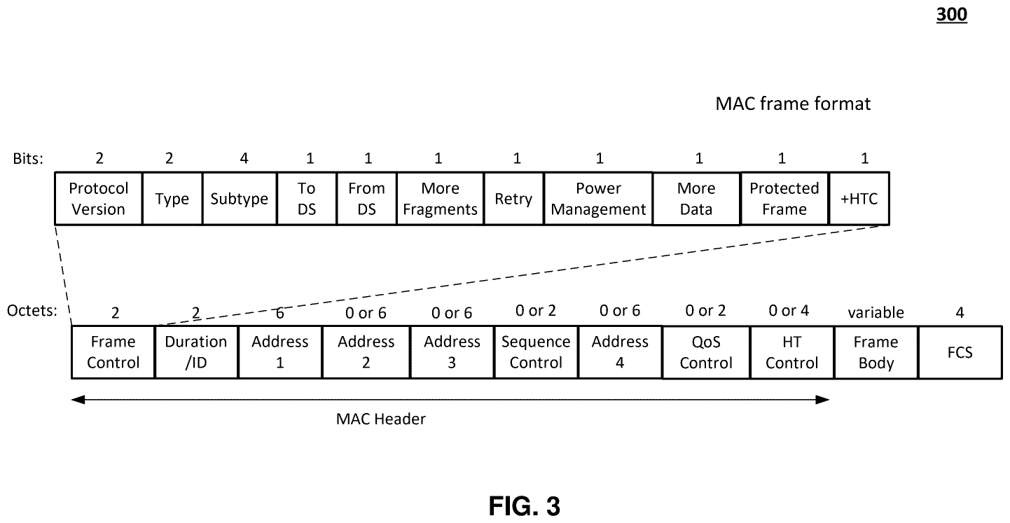

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the format of MAC frame 300. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

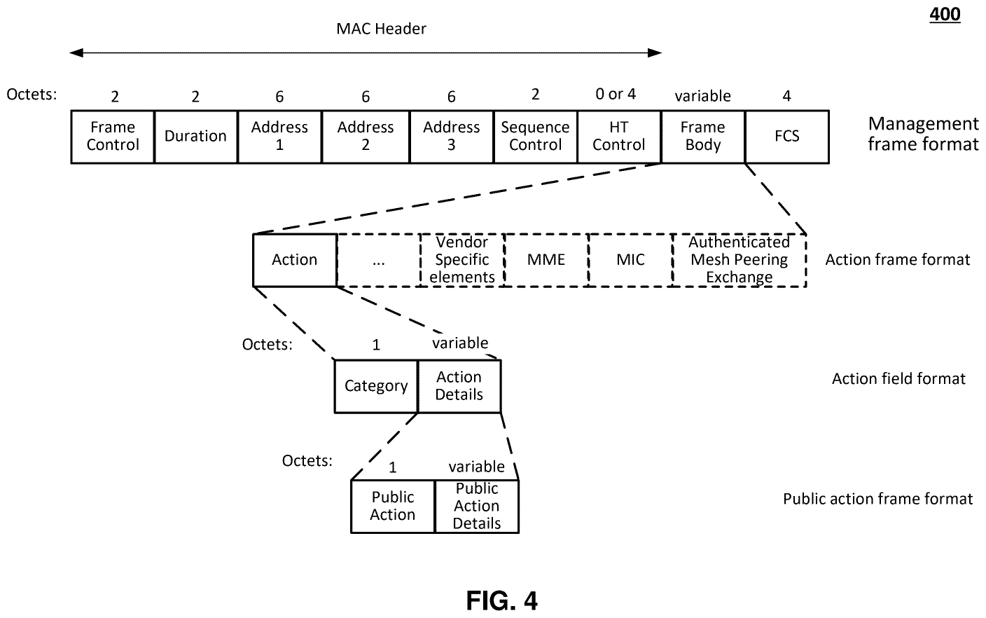

FIG. 4 illustrates an example management frame 400 which may be used as an action frame. In example, management frame 400 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, management message integrity code element (MME), message integrity code (MIC), and an authenticated mesh peering exchange element.

The action field includes a category field and an action details field. The action field provides a mechanism for specifying extended management actions. The category field indicates a category of the action frame. The action details field contains the details of the action requested by the action frame. For example, the action frame may be a public action frame. As shown in FIG. 4, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

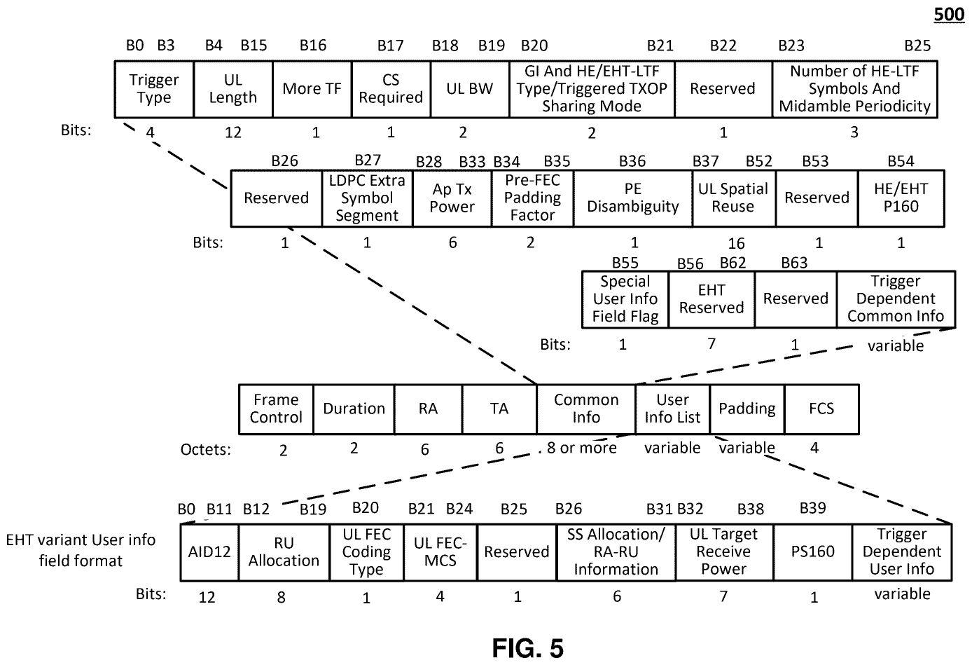

FIG. 5 illustrates an example format of a trigger frame 500. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are the Special User Info field, the EHT variant User Info field, and the HE variant User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth (BW) Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The EHT variant User Info field contains a User Info field per STA addressed in trigger frame 500. The per STA User Info field includes, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU transmitted in response to trigger frame 500, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, identifies the size and the location of the RU or MRU. The values of PS160 subfield and B0 of RU Allocation subfield indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS160 subfield indicates the 160 MHz segment in which the RU or MRU is located for 2996-tone RU, 996+484-tone MRU, and 996+484+242-tone MRU. The UL FEC Coding Type subfield of the User Info field indicates the code type of the solicited EHT TB PPDU. The UL FEC Coding Type subfield is set to 0 to indicate BCC and set to 1 to indicate LDPC. The UL EHT-MCS subfield of the User Info field indicates the EHT-MCS of the solicited EHT TB PPDU. The SS Allocation subfield of the EHT variant User Info field indicates the spatial streams of the solicited EHT TB PPDU. The UL Target Receive Power subfield indicates the expected receive signal power, measured at the AP's antenna connector and averaged over the antennas, for the EHT portion of the EHT TB PPDU transmitted on the assigned RU. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA. The RA-RU Information subfield is reserved in the EHT variant User Info field.

The Padding field is optionally present in management frame 400 to extend the frame length to give recipient STAs enough time to prepare a response for transmission one SIFS after the frame is received. The Padding field, if present, is at least two octets in length and is set to all 1s.

The FCS field is used by a STA to validate a received frame and to interpret certain fields from the MAC headers of a frame.

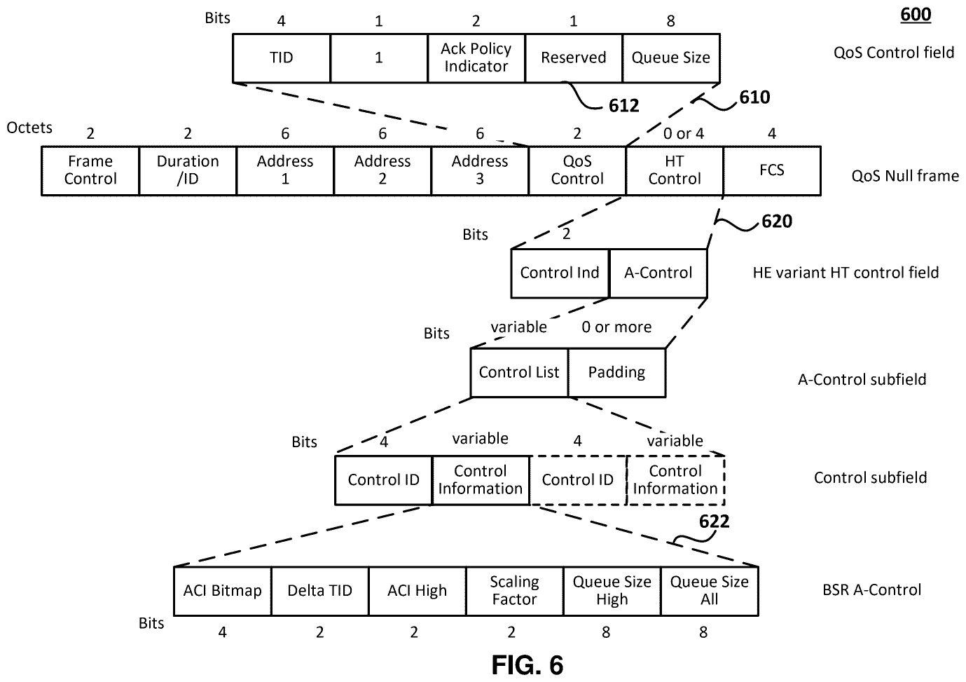

FIG. 6 illustrates an example data frame 600 which may be used as a QoS null frame. A QoS null frame refers to a QoS data frame with an empty frame body. QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgment (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:

$$QS = 16 \times UV , if SF is equal to 0 ;$$

$$1024 + 256 \times UV , if SF is equal to 1 ;$$

$$17 \; 408 + 2048 \times UV , if SF is equal to 2 ;$$

$$148 \; 480 + 32 \; 768 \times UV , if SF is equal to 3 and UV is less than 62 ;$$

$$> 2 \; 147 \; 328 , if SF equal to is 3 and UV is equal to 62 ;$$

$$Unspecified or Unknown , if SF is equal to 3 and UV is equal to 63.$$

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include an aggregated control (A-Control) subfield. The A-Control subfield may include a control list subfield including one or more control subfields.

The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

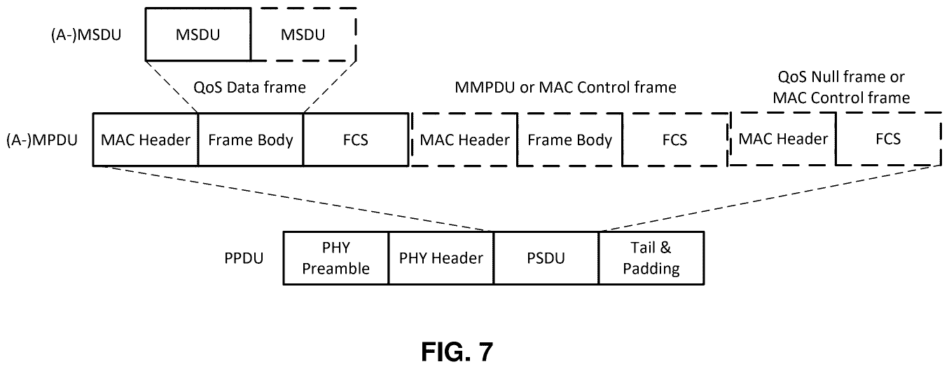

FIG. 7 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

A multi-link device (MLD) is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both the communicating AP MLD and non-AP MLD.

an MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation. After receiving the (re)association request frame containing the TID-to-link mapping element, the AP MLD may reply to the (re)association request frame according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

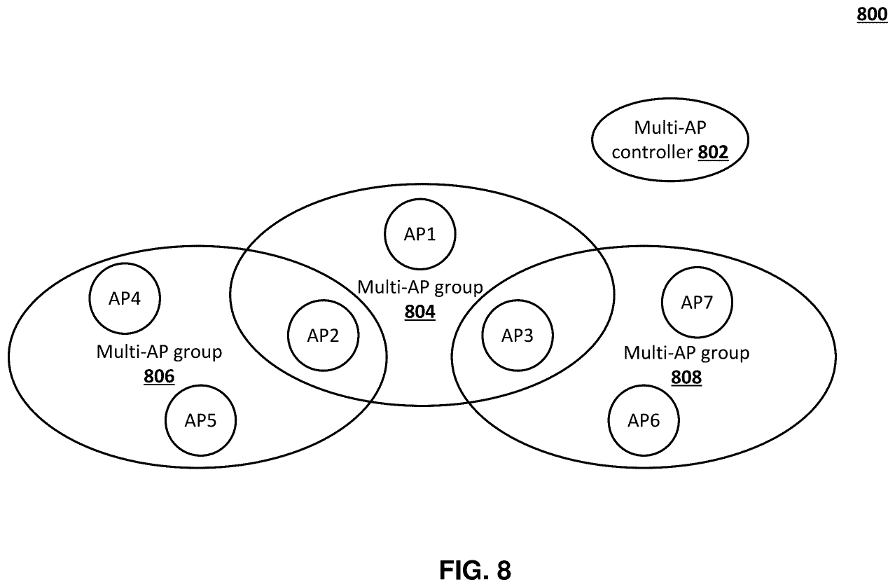

FIG. 8 illustrates an example multi-AP network 800. Example multi-AP network 800 may be a multi-AP network in accordance with the Wi-Fi Alliance standard specification for multi-AP networks. As shown in FIG. 8, multi-AP network 800 may include a multi-AP controller 802 and a plurality of multi-AP groups (or multi-AP sets, or AP candidate sets), including multi-AP group 804, multi-AP group 806, and multi-AP group 808.

Multi-AP controller 802 may be a logical entity that implements logic for controlling the APs in multi-AP network 800. Multi-AP controller 802 may receive capability information and measurements from the APs and may trigger AP control commands and operations on the APs. Multi-AP controller 802 may also provide onboarding functionality to onboard and provision APs onto multi-AP network 800.

Multi-AP group 804, multi-AP group 806, and multi-AP group 808 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by multi-AP controller 802 or by the APs of the multi-AP group. The master AP of a multi-AP group may be fixed or may change over time between the APs of the multi-AP group. An AP that is not the master AP of the multi-AP group is known as a slave AP.

In one approach, a multi-AP group or an AP candidate set is a set of APs that can initiate or participate in multi-AP coordination. An AP in a multi-AP group can participate as a slave AP in multi-AP coordination initiated by a master AP in the same multi-AP group. At least one AP in a multi-AP group shall be capable of being a master AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a period. The period of simultaneous AP transmission may be a continuous period.

Multi-AP group coordination may be enabled by the multi-AP controller and/or by the master AP of the multi-AP group. In one approach, the multi-AP controller and/or the master AP may control time and/or frequency sharing in a TXOP. For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Multi-AP operation may be enabled by at least two APs that support multi-AP coordination within one or more multi-AP groups. The APs may support multi-AP transmission schemes in a multi-AP network. A master AP may coordinate with slave AP(s) to enable multi-AP coordination and to support a multi-AP transmission. Slave AP(s) may participate in a multi-AP transmission. The master AP may select the slave AP(s) which are suitable for the multi-AP transmission. Slave APs may be candidates for a multi-AP transmission before being designated by the master AP.

Multi-AP transmission schemes may include transmission schemes such as coordinated OFDMA, coordinated time division multiple access (TDMA), coordinated spatial reuse, coordinated beamforming, joint transmission or reception (JT/JR), or a combination of two or more of the aforementioned schemes.

Coordinated OFDMA and coordinated TDMA may be categorized as coordinated TXOP, in which frequency or time resources of a TXOP may be used to coordinate the interference. Coordinated spatial reuse (CSR) may provide reuse of spatial domain of neighboring BSSs by adjusting the transmit powers of coordinated APs. Coordinated beamforming (CBF) may provide dedicated null steering with spatial radiation based on channel state information (CSI) feedback from coordinated APs with the aid of multiple antennas to suppress the interference. JT/JR may use distributed MIMO precoding or detection, via shared CSI, for data streams among multiple APs.

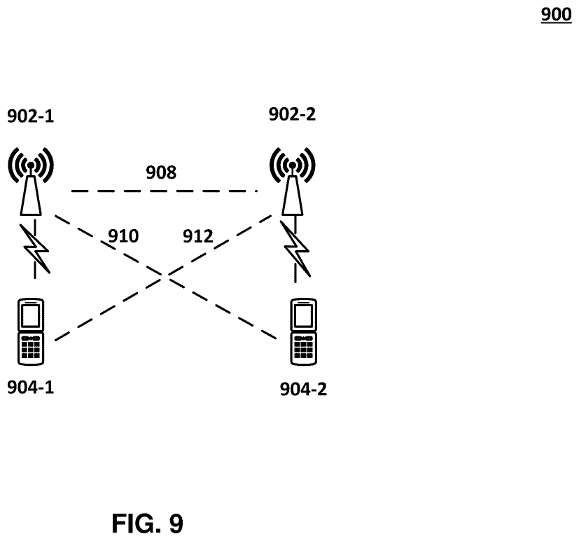

FIG. 9 illustrates an example network 900 that includes a coordinated AP set. As shown in FIG. 9, the coordinated AP set may include AP 902-1 and AP 902-2. The coordinated AP set may be a subset of an established multi-AP group. At least one STA may be associated with each of APs 902-1 and 902-2. For example, a STA 904-1 may be associated with AP 902-1, and a STA 904-2 may be associated with AP 902-2.

APs 902-1 and 902-2 may belong to the same ESS as described above in FIG. 1. In such a case, APs 902-1 and 902-2 may be connected by a DS to support ESS features. In addition, as part of a coordinated AP set, APs 902-1 and 902-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 902-1 and 902-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 9, if AP 902-1 supports JT and CSR while AP 902-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 901-1 and AP 902-2 as shown in FIG. 9. Spatial reuse using CSR can be more stable than non-AP coordinated spatial reuse schemes such as overlapping basic service set (OBSS) packet detect (PD)-based SR and PSR-based SR. For example, in example network 900, APs 902-1 and 902-2 may perform a joint sounding operation in order to measure path loss (PL) on paths of network 900. For example, the joint sounding operation may result in the measurement of PL 908 for the path between APs 902-1 and 902-2, path loss 910 for the path between AP 902-1 and STA 904-2, and path loss 912 for the path between AP 902-2 and STA 904-1. The measured path loss information may then be shared between APs 902-1 and 902-2 (e.g., using the backhaul) to allow for simultaneous transmissions by APs 902-1 and 902-2 to their associated STAs 904-1 and 904-2 respectively. Specifically, one of APs 902-1 and 902-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

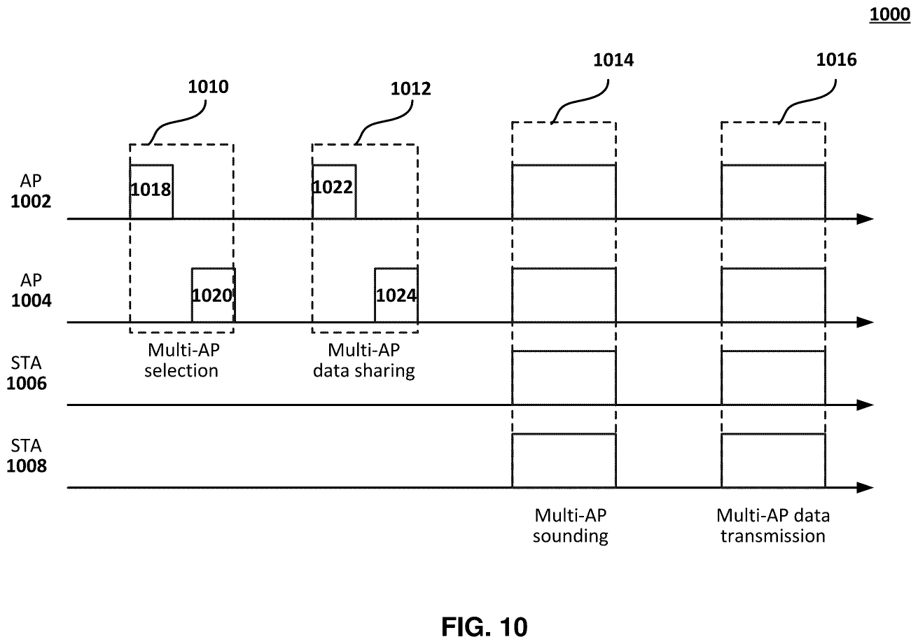

FIG. 10 illustrates an example 1000 of a multi-AP operation procedure. In example 1000, the multi-AP operation procedure is illustrated with respect to a multi-AP network that includes APs 1002 and 1004 and STAs 1006 and 1008. In an example, APs 1002 and 1004 may form a multi-AP group. AP 1002 may be the master AP and AP 1004 may be a slave AP of the multi-AP group. For example, AP 1002 may obtain a TXOP making it the master AP of the multi-AP group. Alternatively, AP 1002 may be designated as the master AP by a multi-AP controller.

As shown in FIG. 10, the multi-AP operation procedure may include a series of phases in time, each of which may contain a plurality of frame exchanges within the multi-AP network. Specifically, the multi-AP operation procedure may include a multi-AP selection phase 1010, a multi-AP data sharing phase 1012, a multi-AP sounding phase 1014, and a multi-AP data transmission phase 1016.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 1010 may include procedures for soliciting, selecting, or designating slave AP(s) for a multi-AP group by a master AP. As seen in FIG. 10, the multi-AP selection phase may include transmissions of frame 1018 from AP 1002 and frame 1020 from AP 1004. AP 1002 may transmit frame 1018 to solicit information regarding the buffer status of AP 1004. In response, AP 1004 may transmit frame 1020 to inform AP 1002 of its and its associated STAs buffer status and/or whether it intends to join multi-AP operation. Multi-AP selection phase 1010 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 1012 may include procedures for sharing data frames to be transmitted by APs to associated STAs among the master AP and selected slave AP(s) via direct connections between APs. Phase 1012 may be optional for some multi-AP data transmission schemes. For example, phase 1012 may be required for JT/JR as data frames may be exchanged between APs before or after multi-AP data transmission phase 1016.

Multi-AP data sharing phase 1012 may be performed using a wired backhaul, an in-channel wireless backhaul, or an off-channel wireless backhaul. In some cases, multi-AP data sharing phase 1012 may be performed over an in-channel backhaul, e.g., using the same wireless channel used to transmit/receive data to/from STAs. For example, as shown in FIG. 10, in phase 1012, AP 1002 may transmit a frame 1022, which may be received by AP 1004. Frame 1022 may include MPDUs that AP 1002 wishes to transmit to associated STAs using a multi-AP operation. Similarly, AP 1004 may transmit a frame 1024, which may be received by AP 1002. Frame 1024 may include MPDUs that AP 1004 wishes to transmit to associated STAs using a multi-AP operation.

Multi-AP sounding phase 1014 may include procedures for multi-AP channel sounding, including channel estimation and feedback of channel estimates among the master AP, candidate slave AP(s), and associated STAs. Phase 1014 may be optional for some multi-AP transmission schemes, such as COFDMA, CDTMA, and CSR. For example, phase 1014 may be performed by the master AP to aid in resource unit allocation when orchestrating a COFDMA transmission.

Multi-AP data transmission phase 1016 may include exchange of data frames between the master AP, slave AP(s), and their associated STAs based on multi-AP transmission scheme(s) determined by the master AP. Depending on the multi-AP transmission scheme(s) to be used, phase 1016 may include optional synchronization between APs of the multi-AP group, before exchange of dataframes between APs and STAs within the multi-AP group.

The order of phases 1010, 1012, 1014 and 1016 may be different than shown in FIG. 10. For example, in COFDMA, phase 1016 may occur immediately after phase 1010, whereas, in JT/JR, phase 1012 may occur after phase 1010. Further, as mentioned above, some phases may be optional and may or may not be present. For example, phase 1014 may not be required for COFDMA but may be required for JT/JR.

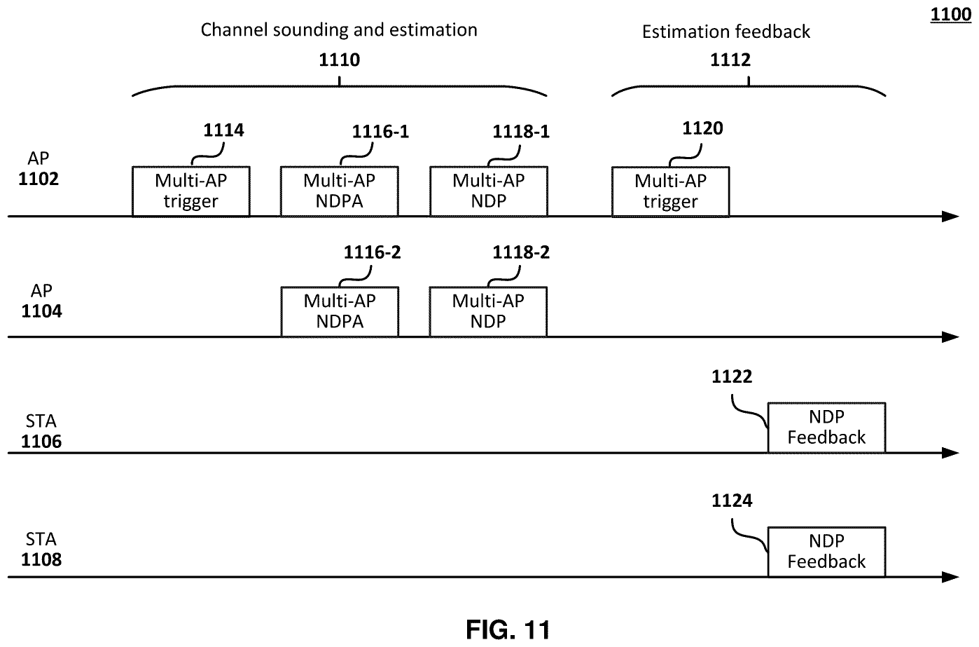

FIG. 11 illustrates an example 1100 of a multi-AP sounding phase. Multi-AP sounding phase 1100 may be an example of multi-AP sounding phase 1014. As shown in FIG. 11, example 1100 may include a master AP 1102 and a slave AP 1104 of a multi-AP group. Example 1100 may further include a STA 1106 associated with AP 1102 and a STA 1108 associated with AP 1104.

As shown in FIG. 11, multi-AP sounding phase 1100 may include frame exchanges to allow AP 1102 (the master AP) to acquire channel state information (CSI) of channels in the multi-AP group. In an implementation, phase 1100 may include a first subphase 1110 and a second subphase 1112.

During the first subphase 1110, APs may initiate channel sounding and STAs may estimate CSI. For example, AP 1102 may transmit a frame 1114 to AP 1104 (the slave AP) to trigger multi-AP sounding. Frame 1114 may comprise a multi-AP trigger frame. Subsequently, APs 1102 and 1104 may transmit respectively announcement frames 1116-1 and 1116-2 to their respective associated STAs 1106 and 1108 to announce the transmission of sounding frames. Frames 1116-1 and 1116-2 may comprise multi-AP null data packet announcement (NDPA) frames. Frames 1116-1 and 1116-2 may be transmitted simultaneously. Next, APs 1102 and 1104 may transmit respectively frames 1118-1 and 1118-2 to STAs 1106 and 1108, respectively. Frames 1118-1 and 1118-2 may comprise multi-AP null data packet (NDP) frames. STAs 1106 and 1108 receive frames 1118-1 and 1118-2 respectively and perform channel estimation of the channels from AP 1102 to STA 1106 and from AP 1104 to STA 1108, respectively.

During the second subphase 1112, APs may initiate a procedure for STAs to feed back channel estimates to the APs. For example, AP 1102 may transmit a frame 1120 to trigger STAs 1106 and 1108 to transmit their channel estimates to APs 1102 and 1104, respectively. Frame 1120 may comprise a multi-AP trigger frame. In response, STAs 1106 and 1108 may transmit respectively frames 1122 and 1124 including feedback of channel estimates to APs 1102 and 1104, respectively. Frames 1122 and 1124 may comprise NDP feedback frames. The feedback of channel estimates may include NDP feedback, CSI-related information, a beamforming report (BFR), or a channel quality indication (CQI) report.

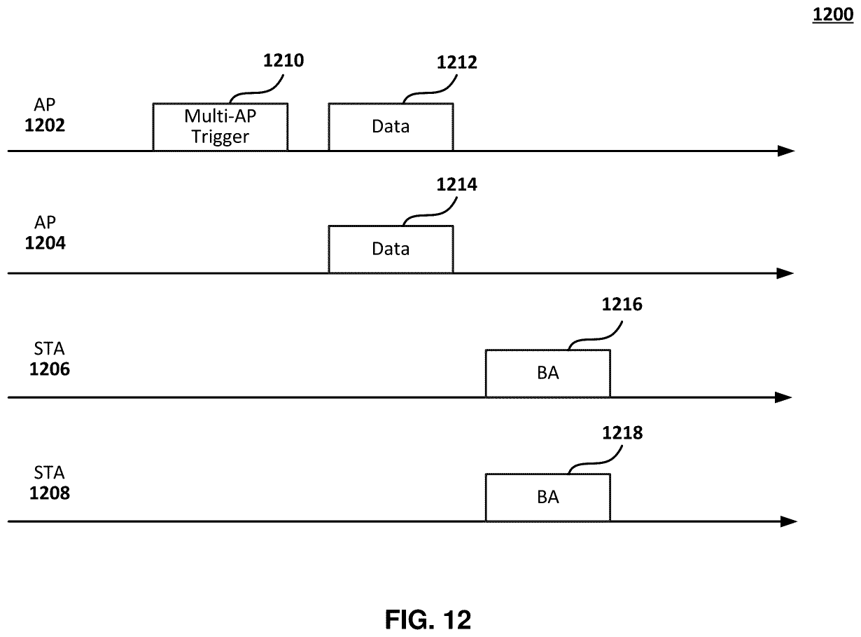

FIG. 12 illustrates an example 1200 of a multi-AP downlink data transmission phase. Multi-AP downlink data transmission phase 1200 may be an example of multi-AP data transmission phase 1016. As shown in FIG. 12, example 1200 may include a master AP 1202 and a slave AP 1204 of a multi-AP group. Example 1200 may further include a STA 1206 associated with AP 1202, and a STA 1208 associated with AP 1204.

As shown in FIG. 12, multi-AP downlink data transmission phase 1200 may include frame exchanges to enable master AP 1202 to coordinate with slave AP 1204 to perform specific multi-AP transmission schemes with their associated STAs 1206 and 1208, respectively. The multi-AP transmission schemes may include COFDMA, CTDMA, CSR, CBF, JT/JR, or a combination of two or more of the aforementioned schemes.

As shown in FIG. 12, master AP 1202 may begin phase 1200 by transmitting a frame 1210 to AP 1204. Frame 1210 may include information related to AP 1204 (e.g., an identifier of AP 1204), synchronization information, information related to a specific multi-AP transmission scheme to be used, and/or information related to a resource unit (RU) for use by AP 1204 to acknowledge frame 1210. Frame 1210 may comprise a control frame. For example, frame 1210 may comprise a multi-AP trigger frame.

Slave AP 1204 may receive frame 1210 and may use the synchronization information to synchronize with master AP 1202. Subsequently, APs 1202 and 1204 may perform data transmission to their associated STAs 1206 and 1208, respectively. Specifically, AP 1202 may transmit a data frame 1212 to its associated STA 1206, and AP 1204 may transmit a data frame 1214 to its associated STA 1208. Depending on the multi-AP transmission scheme being used, APs 1202 and 1204 may transmit frames 1212 and 1214 respectively to STAs in different BSSs. For example, when the multi-AP transmission scheme is JT/JR, AP 1202 may also transmit frame 1212 to STA 1208 associated with slave AP 1204, and AP 1204 may also transmit frame 1214 to STA 1208 associated with AP 1204. The resources for transmitting and receiving frames 1212 and 1214 may depend on the specific multi-AP transmission scheme adopted.

STAs 1206 and 1208 may acknowledge frames 1212 and 1214, respectively. For example, STA 1206 may transmit a frame 1216 to AP 1202, and STA 1208 may transmit a frame 1218 to AP 1204. Frames 1216 and 1218 may comprise block ack (BA) frames. STAs 1206 and 1208 may also transmit frames 1216 and 1218 to APs in different BSSs, when required by the used multi-AP transmission scheme. For example, when the multi-AP transmission scheme is JT/JR, STA 1206 may also transmit frame 1216 to AP 1204, and STA 1208 may also transmit frame 1218 to AP 1202. The resources for transmitting and receiving frames 1216 and 1218 may depend on the specific multi-AP transmission scheme adopted.

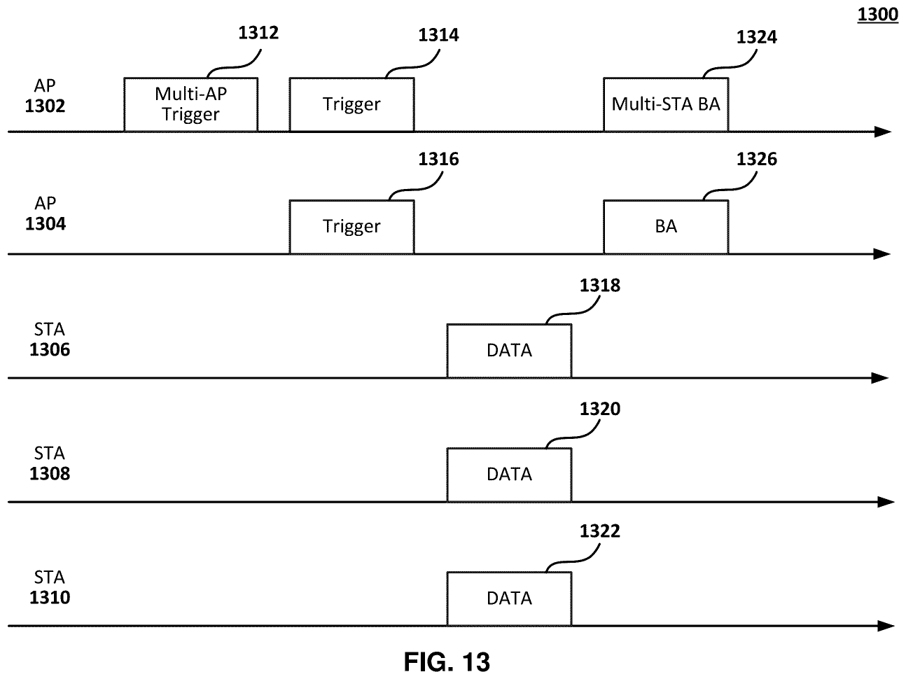

FIG. 13 illustrates an example 1300 of a multi-AP uplink data transmission phase. Multi-AP uplink data transmission phase 1300 may be an example of multi-AP data transmission phase 1016. As shown in FIG. 13, example 1300 may include a master AP 1302 and a slave AP 1304 of a multi-AP group. Example 1300 may further include STAs 1306 and 1308 associated with AP 1302, and a STA 1310 associated with AP 1304.

As shown in FIG. 13, multi-AP uplink data transmission phase 1300 may include frame exchanges to enable master AP 1302 to coordinate with slave AP 1304 to perform specific multi-AP transmission schemes with STAs 1306, 1308, and 1310. The multi-AP transmission schemes may include COFDMA, CTDMA, CSR, CBF, JT/JR, or a combination of two or more of the aforementioned schemes.

As shown in FIG. 13, master AP 1302 may begin phase 1300 by transmitting a frame 1312 to AP 1304. Frame 1312 may include information related to AP 1304 (e.g., an identifier of AP 1304), synchronization information, information related to a specific multi-AP transmission scheme to be used, and/or information related to an RU for use by AP 1304 to acknowledge frame 1312. Frame 1312 may comprise a control frame. For example, frame 1312 may comprise a multi-AP trigger frame.

Slave AP 1304 may receive frame 1312 and may use the synchronization information to synchronize with master AP 1302. Subsequently, APs 1302 and 1304 may solicit uplink data transmissions from their associated STAs 1306, 1308 and 1310 using trigger frames. Specifically, AP 1302 may transmit a trigger frame 1314 to its associated STAs 1306 and 1308, and AP 1304 may transmit a trigger frame 1316 to its associated STA 1310. Depending on the multi-AP transmission scheme being used, APs 1302 and 1304 may also transmit frames 1314 and 1316 respectively to STAs in different BSSs. For example, when the multi-AP transmission scheme is JT/JR, AP 1302 may also transmit frame 1314 to STA 1310 associated with slave AP 1304, and AP 1304 may also transmit frame 1316 to STAs 1306 and 1308 associated with AP 1302. The resources for transmitting and receiving frames 1314 and 1316 may depend on the specific multi-AP transmission scheme adopted.

STAs 1306 and 1308 may respond to frame 1314, STA 1310 may respond to frame 1316. For example, STAs 1306 and 1308 may transmit frames 1318 and 1320 respectively to AP 1302, while STA 1310 may transmit a frame 1322 to AP 1304. Frames 1318, 1320, and/or 1322 may be transmitted simultaneously. Frames 1318, 1320, and 1322 may comprise data frames or null data frames. STAs 1306, 1308, and 1310 may also transmit frames 1318, 1320, and 1322 respectively to APs in different BSSs, when required by the used multi-AP transmission scheme. For example, when the multi-AP transmission scheme is JT/JR, STAs 1306 and 1308 may also transmit respective frames 1318 and 1320 to AP 1304, and STA 1310 may also transmit frame 1322 to AP 1302. The resources for transmitting and receiving frames 1318, 1320, and 1322 may depend on the specific multi-AP transmission scheme adopted.

One function of the MAC sublayer is to transfer MAC service data units (MSDUs) between MAC sublayer entities. The information required for the distribution system service to operate is provided by the association services. Before an MSDU can be handled by the distribution system service, a STA is “associated.”

Three transition types are defined according to the IEEE 802.11 standard:
a) No-transition: In this type, two subclasses that are usually indistinguishable are identified: 1) Static—no motion. 2) Local movement—movement within the PHY range of the communicating STAs, i.e., movement within a basic service area (BSA).
b) BSS-transition: This type is defined as a STA movement from one BSS in one ESS to another BSS within the same ESS. A fast BSS transition is a BSS transition that establishes the state necessary for data connectivity before the reassociation rather than after the reassociation.
c) ESS-transition: This type is defined as STA movement from a BSS in one ESS to a BSS in a different ESS. This case is supported only in the sense that the STA might move.

To deliver an MSDU within an ESS via the DS, the DS needs to know which AP within the ESS to deliver the MSDU, so that the MSDU might ultimately be delivered to the addressed IEEE 802.11 STA. This information is provided to the DS by the concept of association. Association is necessary, but not sufficient, to support BSS-transition mobility. Association is sufficient to support no-transition mobility. Association is one of the services in the DSS.

Before a STA is allowed to send an MSDU via an AP, it first becomes associated with the AP.

At any given instant, a STA is associated with no more than one AP. This allows the DS to determine a unique answer to the question, “Which AP is serving STA X?” Once an association is completed, a STA can make full use of a DS (via the AP) to communicate. Association is always initiated by the non-AP STA, not the AP.

An AP might be associated with many STAs at the same time.

A STA learns what APs are present and what operational capabilities are available from each of those APs and then invokes the association service to establish an association. A FILS STA is able to discover, authenticate and associate with the AP with a reduced number of frame transmissions.

Association is sufficient for no-transition MSDU delivery between IEEE 802.11 STAs. Additional functionality is needed to support BSS-transition mobility. The additional required functionality is provided by the reassociation service. Reassociation is one of the services in the DSS.

The reassociation service is invoked to “move” a current association of a non-AP STA from one AP to another. In an ESS, the reassociation service informs the DS of the current mapping between AP and STA as the STA moves from BSS to BSS within the ESS. Reassociation also enables changing association attributes of an established association while the non-AP STA remains associated with the same AP. Reassociation is always initiated by the non-AP STA.

The disassociation service is invoked when an existing association is to be terminated. Disassociation is one of the services in the DSS.

The disassociation service can be invoked by either party in an association (non-AP STA or AP). Disassociation is a notification, not a request. Disassociation cannot be refused by the receiving STA except when management frame protection is negotiated and the message integrity check fails.

An AP can disassociate STAs to enable the AP to be removed from a network for service or for other reasons.

STAs attempt to disassociate when they leave a network. However, the MAC protocol does not depend on STAs invoking the disassociation service. (MAC management is designed to accommodate loss of communication with an associated STA.)

It is anticipated that future IEEE 802.11 standards provide various mechanisms to support the quality of service (QoS) requirements of low-latency and smooth transfer (or seamless roaming) of STAs.

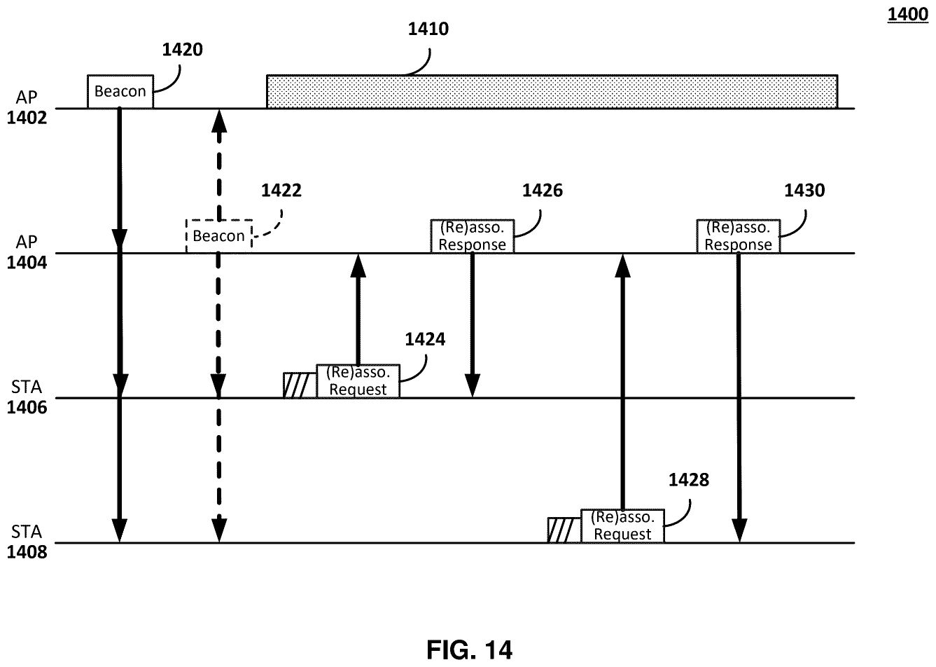

FIG. 14 is an example 1400 that illustrates an existing STA (re)association procedure. As shown in FIG. 14, example 1400 includes an AP 1402, an AP 1404, a STA 1406, and a STA 1408. In an example, STA 1406 and STA 1408 may be associated with AP 1402.

In an example, APs 1402 and 1404 may belong to the same ESS as described above in FIG. 1. In such a case, APs 1402 and 1404 may be connected by a DS to support ESS features. In an example, APs 1402 and 1404 belong to different BSSs.

In an example, APs 1402 and 1404 may form a multi-AP group. In an example, APs 1402 and 1404 may complete a multi-AP setup procedure prior to the beginning of example 1400. In addition, as part of a multi-AP group, APs 1402 and 1404 may be connected by a backhaul. In an example, the backhaul may be a wireless backhaul.

It is assumed in example 1400 that AP 1402 may be scheduled to become unavailable for a time period 1410. For example, AP 1402 may comprise a battery-powered AP (e.g., a mobile AP) that is scheduled to enter a power save mode during time period 1410. Time period 1410 may correspond to a doze state (of the power save mode) in which AP 1402 may not communicate at all. Alternatively, time period 1410 may correspond to a low power consumption state (of the power save mode) in which AP 1402 may not be able to handle all of its currently associated STAs. Alternatively, time period 1410 may correspond to a power off state (of the power save mode) of AP in which AP 1402 may be powered off.

As shown in FIG. 14, example 1400 may begin with AP 1402 transmitting a beacon frame 1420. In an example, beacon frame 1420 may comprise a service set identification (SSID) of AP 1402. In an example, beacon frame 1420 may indicate that AP 1402 is scheduled to become unavailable for time period 1410. For example, beacon frame 1420 may indicate a power save mode schedule of AP 1402.

On receiving beacon frame 1420, STA 1406 may transmit a (re)association request frame 1424 requesting to (re)associate with AP 1404. In an example, STA 1406 may be aware of the presence of AP 1404 based on receiving a beacon frame 1422 from AP 1404. In another example, STA 1406 may be aware of the presence of AP 1404 based on AP 1404 being in a multi-AP group with AP 1402. In an example, (re)association request frame 1424 may comprise capability information of STA 1406. In an example, (re)association request frame 1424 may further comprise an SSID of AP 1404. In another example, (re)association request frame 1424 may comprise a current AP address of AP 1402.

In an example, AP 1404 may transmit a (re)association response frame 1426 to STA 1406 in response to (re)association request frame 1424. For example, frame 1426 may indicate acceptance by AP 1404 of the (re)association request from STA 1406.

Similarly, on receiving beacon frame 1420, STA 1408 may transmit a (re)association frame 1428 requesting to (re)associate with AP 1404. In an example, STA 1408 may be aware of the presence of AP 1404 based on receiving a beacon frame 1422 from AP 1404. In another example, STA 1408 may be aware of the presence of AP 1404 based on AP 1404 being in a multi-AP group with AP 1402. In an example, the (re)association request frame 1428 may comprise capability information of STA 1408. In an example, the (re)association request frame 1428 may further comprise an SSID of AP 1404. In another example, the (re)association request frame 1428 may comprise a current AP address of AP 1402.

In an example, AP 1404 may transmit a (re)association response frame 1430 to STA 1408 in response to (re)association request frame 1428. For example, frame 1428 may indicate an acceptance by AP 1404 of the (re)association request from STA 1408.

As shown in example 1400, beacon frame 1420 results in each of STAs 1406 and 1408 initiating a separate (re)association procedure to (re)associate with AP 1404. When the number of STAs requiring (re)association is large, the (re)association procedures may necessitate a significant amount of time, which may introduce significant latency and overhead in the multi-AP network.

Embodiments of the present disclosure, as further described below, address the above-described problems of existing multi-AP procedures. In an embodiment, a first AP may receive from a second AP, a first frame requesting association transfer of a STA from the second AP to the first AP. In an embodiment, based on receiving the first frame, the first AP may transmit, a second frame indicating association transfer of the STA from the second AP to the first AP. As such, latency incurred by association transfer of multiple STAs may be reduced.

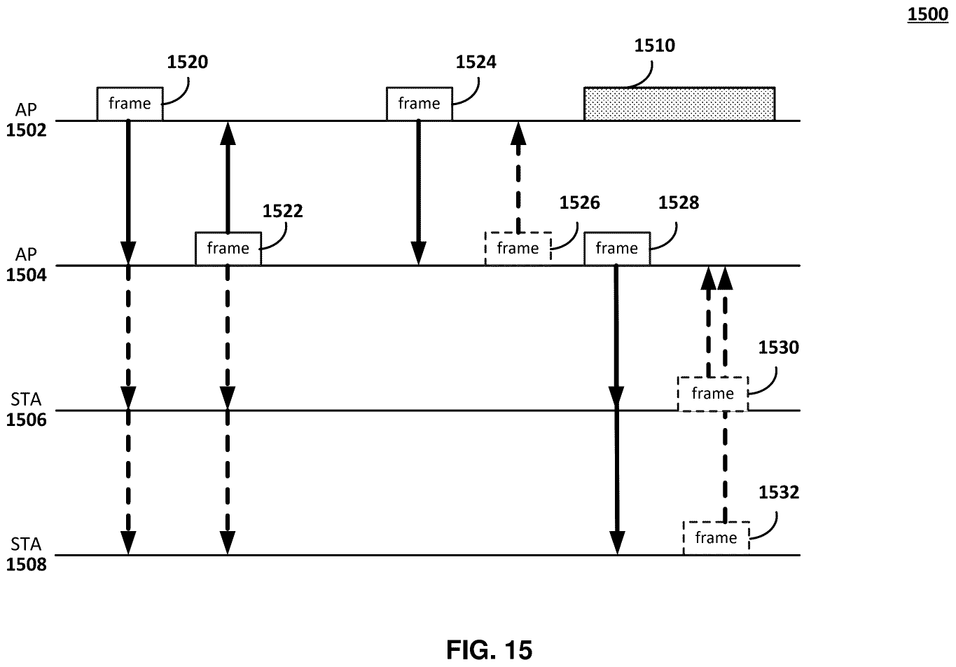

FIG. 15 is an example 1500 that illustrates a multi-AP coordinated station transfer according to an embodiment. Example 1500 is provided for the purpose of illustration only and is not limiting. As shown in FIG. 15, example 1500 includes an AP 1502, an AP 1504, a STA 1506, and a STA 1508. In an example, STA 1506 and STA 1508 may be associated with AP 1502.

In an example, APs 1502 and 1504 may belong to the same ESS as described above in FIG. 1. In such a case, APs 1502 and 1504 may be connected by a DS to support ESS features. In an example, APs 1502 and 1504 belong to different BSSs. In an embodiment, AP 1502 may belong to a first BSS and AP 1504 may belong to a second BSS. In an embodiment, the second BSS may comprise an overlapping basic service set (OBSS) relative to the first BSS.

In an embodiment, AP 1502 and 1504 may form a multi-AP group. It is assumed in example 1500, APs 1502 and 1504 may complete a multi-AP setup procedure prior to example 1500 beginning. In addition, as part of a multi-AP group, APs 1502 and 1504 may be connected by a backhaul. As shown in FIG. 15, the backhaul may be a wireless backhaul.

It is assumed in example 1500 that both AP 1502 and AP 1504 support a STA association transfer capability. In an example, supporting the STA association transfer capability allows AP 1502 to transmit frames (such as frame 1524 described below) to initiate a STA association transfer to AP 1504. In an example, supporting the STA association transfer capability allows AP 1504 to receive and process frames (such as frame 1524 described below) to (re)associate STAs 1506 and 1508. In another example, supporting the STA association transfer capability allows AP 1504 to transmit frames (such as frame 1528 described below) to inform STAs 1506 and 1508 of association transfer.

It is also assumed in example 1500 that both STA 1506 and STA 1508 support the STA association transfer capability. In an example, supporting the STA association transfer capability allows STAs 1506 and 1508 to receive frames (such as frame 1528 described below) informing STAs 1506 and 1508 of association transfer.

In an embodiment, prior to the beginning of example 1500 (not shown in FIG. 15), STAs 1506 and 1508 may initiate association procedures to associate with AP 1502, respectively.

In an embodiment, STA 1506 may transmit to AP 1502 an association request frame. In an embodiment, the association request frame may comprise capability information of STA 1506. The capability information may comprise a first indication of support by STA 1506 of the STA association transfer capability.

In an embodiment, STA 1506 may receive from AP 1502 an association response frame indicating association of STA 1506 with AP 1502. In an embodiment, the association response frame may comprise capability information of AP 1502. The capability information may comprise a second indication of support by AP 1502 of the STA association transfer capability.

In an embodiment, STA 1508 may transmit to AP 1502 an association request frame. In an embodiment, the association request frame may comprise capability information of STA 1508. The capability information may comprise a third indication of support by STA 1508 of the STA association transfer capability.

In an embodiment, STA 1508 may receive from AP 1502 an association response frame indicating association of STA 1508 with AP 1502. In an embodiment, the association response frame may comprise capability information of AP 1502. The capability information may comprise the second indication of support by AP 1502 of the STA association transfer capability.

As shown in FIG. 15, example 1500 may begin with APs 1502 and 1504 transmitting frames 1520 and 1522 respectively to exchange capability information. In an embodiment, frame 1520 may comprise the capability information of AP 1502, including the second indication of support by AP 1502 of STA association transfer capability. In an embodiment, frame 1522 may comprise the capability information of AP 1504, including a fourth indication of support by AP 1504 of STA association transfer capability. In an embodiment, frames 1520 and 1522 may comprise a management frame used as a beacon frame.

It is assumed in example 1500 that AP 1502 may be scheduled to become unavailable for a time period 1510. For example, AP 1502 may comprise a battery-powered AP (e.g., a mobile AP) that is scheduled to enter a power save mode during time period 1510. Time period 1510 may correspond to a doze state (of the power save mode) in which AP 1502 may comprise not communicate at all. Alternatively, time period 1510 may correspond to a low power consumption state (of the power save mode) in which AP 1502 may not be able to handle all of its currently associated STAs. Alternatively, time period 1510 may correspond to a power off state (of the power save mode) of AP in which AP 1502 may be powered off.

In an embodiment, AP 1502 may transmit to AP 1504 a first frame 1524 requesting association transfer of STAs 1506 and 1508 from AP 1502 to AP 1504.

In an embodiment, first frame 1524 may request (re)association of STAs 1506 and 1508 with AP 1504. In an embodiment, first frame 1524 may comprise a reassociation request frame.

In an embodiment, first frame 1524 may comprise identifiers of STAs 1506 and 1508. In an implementation, identifiers of STAs 1506 and 1508 may be MAC addresses of STA 1506 and 1508.

In an embodiment, first frame 1524 may comprise capability information of STA 1506 and capability information of STA 1508. In an example, the capability information of STA 1506 may comprise the first indication of support by STA 1506 of the STA association transfer capability. In an example, the capability information of STA 1508 may comprise the third indication of support by STA 1508 of the STA association transfer capability.

In an embodiment, first frame 1524 may optionally comprise operation information of STA 1506 and operation information of STA 1508. For example, the operation information of STA 1506 or 1508 may comprise a power management mode of STA 1506 or 1508. For example, the operation information of STA 1506 or 1508 may comprise link management information of STA 1506 or 1508.

In an embodiment, first frame 1524 may indicate a reason for the STA association transfer request. For example, the reason may be related to a power management mode of AP 1502 (e.g., entering a doze state, powering off, etc.) or link management information of AP 1502 (e.g., link disablement of a multi-link device), etc.

In an embodiment, first frame 1524 may comprise a management frame.

In an embodiment, AP 1504 may optionally transmit to AP 1502 an acknowledgment frame 1526 in response to first frame 1524.

In an embodiment, based on receiving first frame 1524, AP 1502 may transmit a second frame 1528 indicating association transfer of STAs 1506 and 1508 from AP 1502 to AP 1504.

In an embodiment, second frame 1528 may further indicate association of STAs 1506 and 1508 with AP 1504. In an embodiment, second frame 1528 may comprise an association response frame.

In an embodiment, second frame 1528 may further indicate disassociation of STAs 1506 and 1508 by AP 1502. In an embodiment, second frame 1528 may comprise a disassociation frame.

In an embodiment, second frame 1528 may comprise an aggregate MAC protocol data unit (MPDU) comprising a disassociation frame and an association response frame. In an example, the disassociation frame may indicate disassociation of STAs 1506 and 1508 by AP 1502; and an association response frame informing association of STAs 1506 and 1508 with AP 1504.

In another embodiment, second frame 1528 may further indicate reassociation of STAs 1506 and 1508 with AP 1504. In an embodiment, second frame 1528 may comprise an reassociation response frame.

In an embodiment, second frame 1528 may comprise capability information of AP 1504. In an example, the capability information of AP 1504 may comprise the fourth indication of support by AP 1504 of the STA association transfer capability.

In an embodiment, second frame 1528 may optionally comprise operation information of AP 1504. For example, the operation information of AP 1504 may comprise a power management mode of AP 1504 or link management information of AP 1504, MCS information, NSS set information, channel width information and/or channel center frequency information, etc.

In an embodiment, second frame 1528 may comprise a management frame.

In an embodiment, STA 1506 may optionally transmit AP 1504 an acknowledgment frame 1530 in response to second frame 1528. In an embodiment, STA 1508 may optionally transmit AP 1504 an acknowledgment frame 1532 in response to second frame 1528. Frames 1530 and 1532 may comprise block ack frames.

As shown in example 1500, first frame 1524 and second frame 1528 result in AP 1502 initiating a joint (re)association procedure for both STAs 1506 and 1508 to (re)associate with AP 1504. When the number of STAs requiring (re)association is large, the (re)association procedures may maintain the same amount of time as transferring a single STA, which may reduce significant latency and overhead in the multi-AP network.

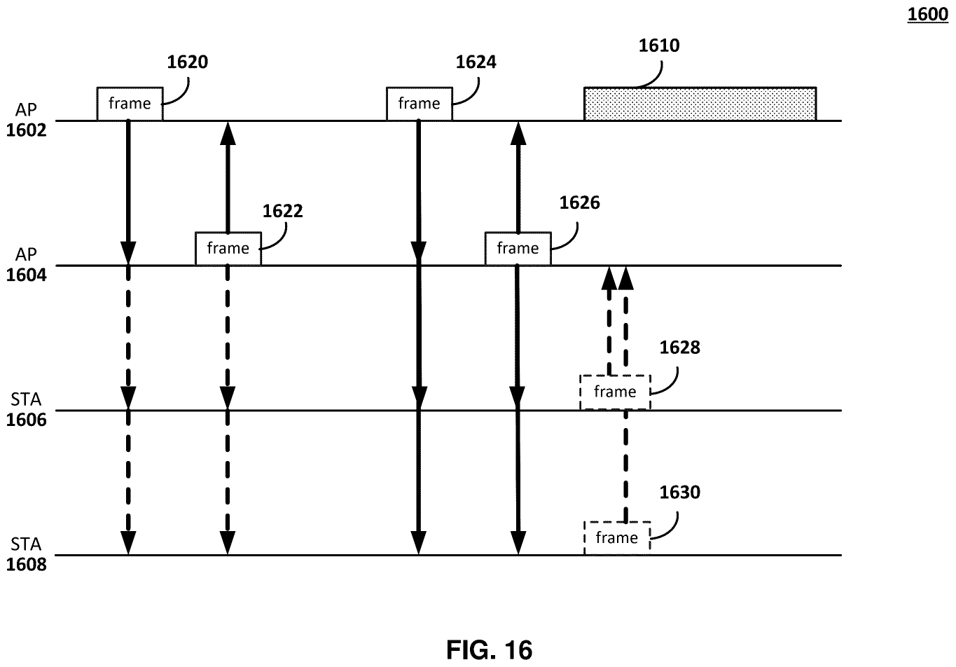

FIG. 16 is an example 1600 that illustrates a multi-AP coordinated station transfer according to an embodiment. Example 1600 is provided for the purpose of illustration only and is not limiting. As shown in FIG. 16, example 1600 includes an AP 1602, an AP 1604, a STA 1606, and a STA 1608. In an example, STA 1606 and STA 1608 may be associated with AP 1602.

In an example, APs 1602 and 1604 may belong to the same ESS as described above in FIG. 1. In such a case, APs 1602 and 1604 may be connected by a DS to support ESS features. In an example, APs 1602 and 1604 belong to different BSSs. In an embodiment, AP 1602 may belong to a first BSS and AP 1604 may belong to a second BSS. In an embodiment, the second BSS may comprise an overlapping basic service set (OBSS) relative to the first BSS.

In an embodiment, AP 1602 and 1604 may form a multi-AP group. It is assumed in example 1600, APs 1602 and 1604 may complete a multi-AP setup procedure prior to example 1600 beginning. In addition, as part of a multi-AP group, APs 1602 and 1604 may be connected by a backhaul. As shown in FIG. 16, the backhaul may be a wireless backhaul.

It is assumed in example 1600 that both AP 1602 and AP 1604 support a STA association transfer capability. In an example, supporting the STA association transfer capability allows AP 1602 to transmit frames (such as first frame 1624 described below) to initiate a STA association transfer to AP 1604. In an example, supporting the STA association transfer capability allows AP 1604 to receive and process frames (such as first frame 1624 described below) to (re)associate STAs 1606 and 1608. In another example, supporting the STA association transfer capability allows AP 1604 to transmit frames (such as frame 1628 described below) to inform STAs 1606 and 1608 of association transfer.

It is also assumed in example 1600 that both STA 1606 and STA 1608 support the STA association transfer capability. In an example, supporting the STA association transfer capability allows STAs 1606 and 1608 to receive frames (such as frame 1628 described below) informing STAs 1606 and 1608 of association transfer.

In an embodiment, prior to the beginning of example 1600 (not shown in FIG. 16), STAs 1606 and 1608 may initiate association procedures to associate with AP 1602, respectively.

In an embodiment, STA 1606 may transmit to AP 1602 an association request frame. In an embodiment, the association request frame may comprise capability information of STA 1606. The capability information may comprise a first indication of support by STA 1606 of the STA association transfer capability.

In an embodiment, STA 1606 may receive from AP 1602 an association response frame indicating association of STA 1606 with AP 1602. In an embodiment, the association response frame may comprise capability information of AP 1602. The capability information may comprise a second indication of support by AP 1602 of the STA association transfer capability.

In an embodiment, STA 1608 may transmit to AP 1602 an association request frame. In an embodiment, the association request frame may comprise capability information of STA 1608. The capability information may comprise a third indication of support by STA 1608 of the STA association transfer capability.

In an embodiment, STA 1608 may receive from AP 1602 an association response frame indicating association of STA 1608 with AP 1602. In an embodiment, the association response frame may comprise capability information of AP 1602. The capability information may comprise the second indication of support by AP 1602 of the STA association transfer capability.

As shown in FIG. 16, example 1600 may begin with APs 1602 and 1604 transmitting frames 1620 and 1622 respectively to exchange capability information. In an embodiment, frame 1620 may comprise the capability information of AP 1602, including the second indication of support by AP 1602 of STA association transfer capability. In an embodiment, frame 1622 may comprise the capability information of AP 1604, including a fourth indication of support by AP 1604 of STA association transfer capability. In an embodiment, frames 1620 and 1622 may comprise a management frame used as a beacon frame.

It is assumed in example 1600 that AP 1602 may be scheduled to become unavailable for a time period 1610. For example, AP 1602 may comprise a battery-powered AP (e.g., a mobile AP) that is scheduled to enter a power save mode during time period 1610. Time period 1610 may correspond to a doze state (of the power save mode) in which AP 1602 may comprise not communicate at all. Alternatively, time period 1610 may correspond to a low power consumption state (of the power save mode) in which AP 1602 may not be able to handle all of its currently associated STAs. Alternatively, time period 1610 may correspond to a power off state (of the power save mode) of AP in which AP 1602 may be powered off.

In an embodiment, AP 1602 may transmit to AP 1604 a first frame 1624 requesting association transfer of STAs 1606 and 1608 from AP 1602 to AP 1604.

In an embodiment, first frame 1624 may request (re)association of STAs 1606 and 1608 with AP 1604. In an embodiment, first frame 1624 may comprise a reassociation request frame.

In an embodiment, first frame 1624 may indicate disassociation of STAs 1606 and 1608 by AP 1602. In an embodiment, first frame 1624 may comprise a disassociation frame. In an embodiment, first frame 1624 may request association of STAs 1606 and 1608 with AP 1604. In an embodiment, first frame 1624 may comprise an association request frame.

In an embodiment, first frame 1624 may comprise an aggregate MAC protocol data unit (MPDU) comprising a disassociation frame and an association request frame. In an example, the disassociation frame may indicate disassociation of STAs 1606 and 1608 by AP 1602; and an association request frame requesting association of the STAs 1606 and 1608 with AP 1604.

In another embodiment, first frame 1624 may not indicate disassociation of STAs 1606 and 1608 by AP 1602. In an embodiment, first frame 1624 may request reassociation of STAs 1606 and 1608 with AP 1604. In an embodiment, first frame 1624 may comprise a reassociation request frame.

In an embodiment, first frame 1624 may comprise identifiers of STAs 1606 and 1608. In an implementation, identifiers of STAs 1606 and 1608 may be MAC addresses of STA 1606 and 1608.

In an embodiment, first frame 1624 may comprise capability information of STA 1606 and capability information of STA 1608. In an example, the capability information of STA 1606 may comprise the first indication of support by STA 1606 of the STA association transfer capability. In an example, the capability information of STA 1608 may comprise the third indication of support by STA 1608 of the STA association transfer capability.

In an embodiment, first frame 1624 may optionally comprise operation information of STA 1606 and operation information of STA 1608. For example, the operation information of STA 1606 or 1608 may comprise a power management mode of STA 1606 or 1608. For example, the operation information of STA 1606 or 1608 may comprise link management information of STA 1606 or 1608.

In an embodiment, first frame 1624 may indicate a reason for the STA association transfer request. For example, the reason may be related to a power management mode of AP 1602 (e.g., entering a doze state, powering off, etc.) or link management information of AP 1602 (e.g., link disablement of a multi-link device), etc.

In an embodiment, first frame 1624 may comprise a management frame.

In an embodiment, based on receiving first frame 1624, AP 1502 may transmit a second frame 1626 indicating association transfer of STAs 1606 and 1608 from AP 1602 to AP 1604.

In an embodiment, second frame 1626 may indicate association of STAs 1606 and 1608 with AP 1604 when first frame 1624 indicates the disassociation of STAs 1606 and 1608 by AP 1602. In an embodiment, second frame 1626 may comprise an association response frame.

In an embodiment, second frame 1626 may further indicate reassociation of STAs 1606 and 1608 with AP 1604. In an embodiment, second frame 1626 may comprise an reassociation response frame.

In an embodiment, second frame 1626 may comprise capability information of AP 1604. In an example, the capability information of AP 1604 may comprise the fourth indication of support by AP 1604 of the STA association transfer capability.

In an embodiment, second frame 1626 may optionally comprise operation information of AP 1604. For example, the operation information of AP 1604 may comprise a power management mode of AP 1604 or link management information of AP 1604, MCS information, NSS set information, channel width information and/or channel center frequency information, etc.

In an embodiment, second frame 1626 may comprise a management frame.

In an embodiment, STA 1606 may optionally transmit AP 1604 an acknowledgment frame 1628 in response to second frame 1626. In an embodiment, STA 1608 may optionally transmit AP 1604 an acknowledgment frame 1630 in response to second frame 1626. Frames 1628 and 1630 may comprise block ack frames.

In an embodiment, first frame 1624 and second frame 1626 described in FIG. 16 may be management frames. The management frame may be used as a (re)association request frame, a (re)association response frame, and a disassociation frame.

In an embodiment, first frame 1624 and second frame 1626 described in FIG. 16 may be management frames, such as beacon frames.

As shown in example 1600, first frame 1624 and second frame 1626 result in AP 1602 initiating a joint (re)association procedure for both STAs 1606 and 1608 to (re)associate with AP 1604. When the number of STAs requiring (re)association is large, the (re)association procedures may maintain the same amount of time as transferring a single STA, which may reduce significant latency and overhead in the multi-AP network.

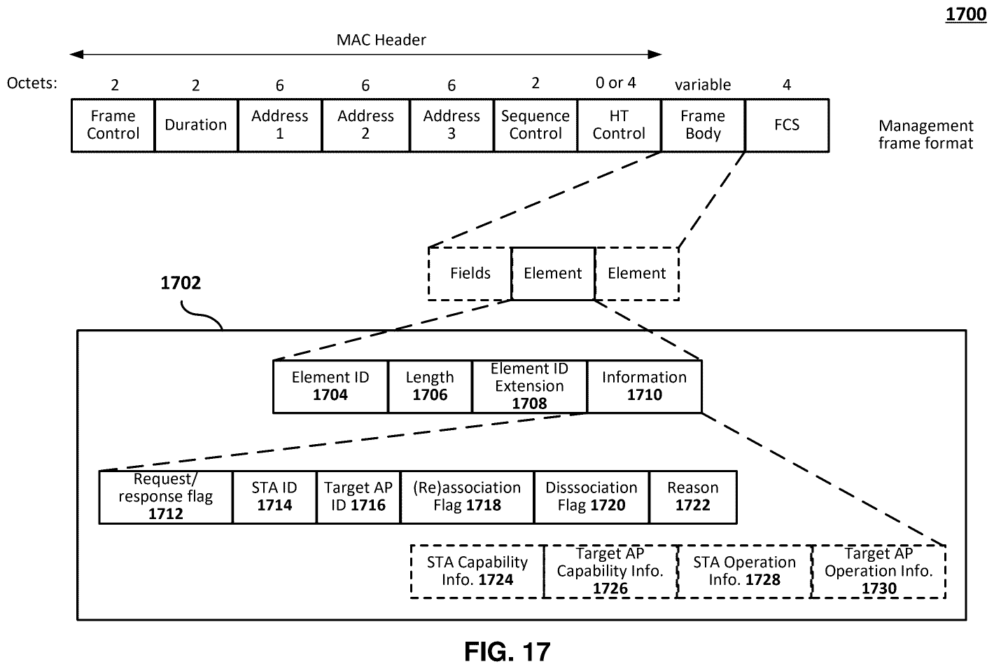

FIG. 17 illustrates an example management frame 1700 which may be used according to embodiments. For example, management frame 1700 may be an embodiment of frames 1524, 1528, 1624, and 1626.

In an example, management frame 1700 may comprise a (re)association request frame, a (re)association response frame, and/or a disassociation frame. For example, management frame 1700 may comprise a (re)association request frame as an embodiment of frame 1524 or 1624. For example, management frame 1700 may comprise a (re)association response frame as an embodiment of frame 1528 or 1626. For example, management frame 1700 may be comprise a disassociation frame as an embodiment of frame 1528 or 1624.

In another example, management frame 1700 may comprise a beacon frame. For example, management frame 1700 may comprise a beacon frame as an embodiment of first frame 1624 or second frame 1626.

In an embodiment, management frame 1700 may indicate a request for or a response to a STA association transfer from an initiating AP to a target AP. The initiating AP may be an embodiment of AP 1502 described in FIG. 15 or AP 1602 described in FIG. 16. The target AP may be an embodiment of AP 1504 described in FIG. 15 or AP 1604 described in FIG. 16.

As shown in FIG. 17, management frame 1700 may include a frame control field, a duration field, one or more address fields, a sequence control field, an HT control field, a frame body, and an FCS field. In an embodiment, the frame body may include an element 1702 indicating a request for or a response to an association transfer of a first STA from the initiating AP to the target AP. In an example, element 1702 may comprise a STA association transfer element. In an embodiment, element 1702 may include an element identifier (ID) field 1704, a length field 1706, an element ID extension field 1708, and an information field 1710. In an embodiment, element 1702 may further indicate a request for or a response to an association transfer of a second STA.

In an embodiment, information field 1710 may include a request/response flag subfield 1712, a STA ID subfield 1714, a target AP ID subfield 1716, a (re)association flag subfield 1718, a disassociation flag subfield 1720, a reason subfield 1722, an optional STA capability information subfield 1724, an optional target AP capability information subfield 1726, an optional STA operation information subfield 1728, and an optional target AP operation information subfield 1730.

In an embodiment, request/response flag subfield 1712 may indicate a request for or a response to an association transfer of STA(s) indicated in STA ID subfield 1714. In an implementation, request/response flag subfield 1712 may take a 0 or 1 value, where a value of 0 indicates a request for an association transfer of STA(s) indicated in STA ID subfield 1714, and a value of 1 indicates a response to an association transfer of STAs indicated in STA ID subfield 1714.

In an embodiment, STA ID subfield 1714 may include identifiers of STA(s) being transferred to the target AP. For example, STA(s) being transferred to the target AP may comprise a first STA and a second STA. In an example, an identifier of the first STA may comprise an address of the first STA. In an example, an identifier of the second STA may comprise an address of the second STA.

In an embodiment, target AP ID subfield 1716 may include an identifier of the target AP of the STA association transfer. In an example, an identifier of the target AP may comprise an address of the target AP.

In an embodiment, (re)association flag subfield 1718 may indicate association or reassociation of the STA(s) indicated in STA ID subfield 1714 with the target AP indicated in target AP ID subfield 1716. In an implementation, (re)association flag subfield 1712 may take a 0 or 1 value, where a value of 0 indicates the association of the STA(s) with the target AP, and a value of 1 indicates the reassociation of the STA(s) with the target AP.

In an embodiment, disassociation flag subfield 1720 may indicate disassociation of the STA(s) indicated in STA ID subfield 1714. In an implementation, disassociation flag subfield 1720 may take a value of 0 or 1. In an example, disassociation flag subfield 1720 may take a value of 1 to indicate disassociation of the STA(s) indicated in STA ID subfield 1714. In an example, disassociation flag subfield 1720 may take a value of 1 when (re)association flag subfield 1718 indicates association of the STA(s) indicated in STA ID subfield 1714. In an example, disassociation flag subfield 1720 may take a value of 0 to indicate disassociation is not being signaled. In an example, disassociation flag subfield 1720 may take a value of 0 when (re)association flag subfield 1718 indicates reassociation of the STA(s) indicated in STA ID subfield 1714.

In an embodiment, reason subfield 1722 may indicate a reason for association transfer of the STA(s) indicated in STA ID subfield 1714. In an example, the reason subfield 1722 may comprise a reason code. In an example, the reason code may indicate that an initiating AP is scheduled to enter a power save mode. For example, the power save mode may comprise a doze state, a low power consumption state, or a power off sate.

In an embodiment, optional STA capability information subfield 1724 may comprise the capability information of the STA(s) indicated in STA ID subfield 1714. In an example, STA capability information subfield 1724 may comprise an indication of support by STA(s) indicated in STA ID subfield 1714 of the STA association transfer capability. In an example, optional STA capability information subfield 1724 may be present when request/response flag subfield 1712 indicates a request for association transfer of the STA(s) indicated in STA ID subfield 1714. In an example, optional STA capability information subfield 1724 may be reserved when request/response flag subfield 1712 indicates a response to an association transfer of the STA(s) indicated in STA ID subfield 1714.

In an embodiment, optional target AP capability information subfield 1726 may comprise the capability information of the target AP indicated in target AP ID subfield 1716. In an example, target AP capability information subfield 1726 may comprise an indication of support by the target AP indicated in target AP ID subfield 1716 of the STA association transfer capability. In an example, optional target AP capability information subfield 1726 may be present when request/response flag subfield 1712 indicates a response to an association transfer of the STA(s) indicated in STA ID subfield 1714. In an example, optional target AP capability information subfield 1726 may be reserved when request/response flag subfield 1712 indicates a request for association transfer of the STA(s) indicated in STA ID subfield 1714.

In an embodiment, optional STA operation information subfield 1728 may comprise operation information of the STA(s) indicated in STA ID subfield 1714. In an example, STA operation information subfield 1728 may indicate a power management mode of STA(s) indicated in STA ID subfield 1714. In an example, STA operation information subfield 1728 may comprise a link management information of STA(s) indicated in STA ID subfield 1714. In an example, optional STA operation information subfield 1728 may be present when request/response flag subfield 1712 indicates a request for an association transfer of the STA(s) indicated in STA ID subfield 1714. In an example, optional STA operation information subfield 1728 may be reserved when request/response flag subfield 1712 indicates a response to an association transfer of the STA(s) indicated in STA ID subfield 1714.

In an embodiment, optional target AP operation information subfield 1730 may comprise operation information of the target AP indicated in target AP ID subfield 1716. For example, target AP operation information subfield 1730 may indicate a power management mode of the target AP, a link management information of the target AP, MCS information, NSS set information, channel width information and/or channel center frequency information, etc. In an example, optional target AP operation information subfield 1730 may be present when request/response flag subfield 1712 indicates a response to an association transfer of the STA(s) indicated in STA ID subfield 1714. In an example, optional target AP operation information subfield 1730 may be reserved when request/response flag subfield 1712 indicates a request for an association transfer of the STA(s) indicated in STA ID subfield 1714.

In an embodiment, first frame 1524 and second frame 1528 described in FIG. 15 may be management frames, such as action frames.

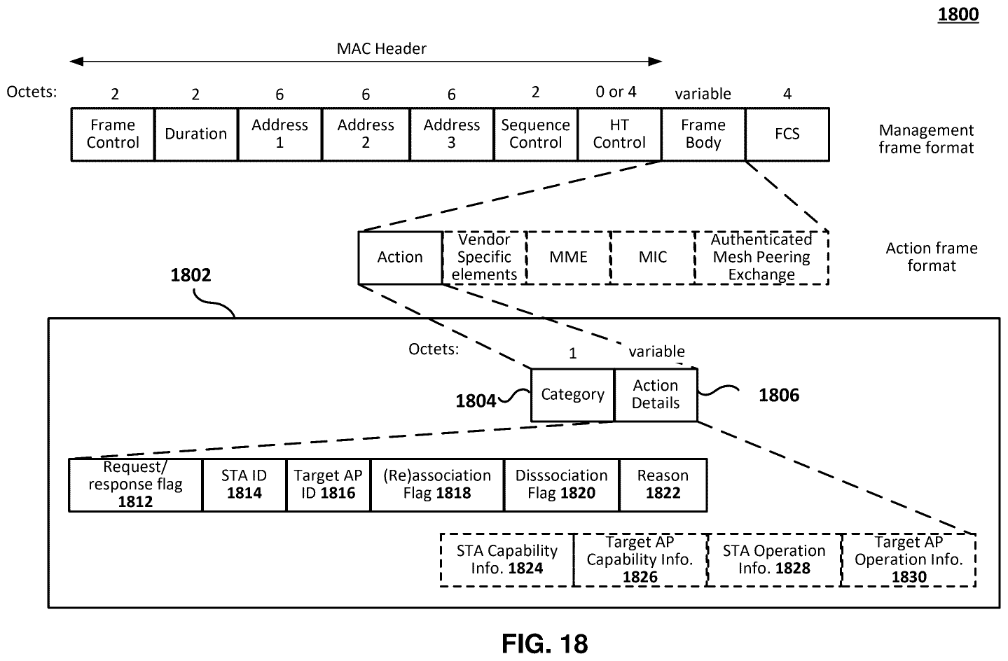

FIG. 18 illustrates an example action frame 1800 which may be used according to embodiments. For example, action frame 1800 may be an embodiment of frames 1524 and 1624. In an example, action frame 1800 may comprise a public action frame.

In an embodiment, action frame 1800 may indicate a request for or a response to a STA association transfer from an initiating AP to a target AP. The initiating AP may be an embodiment of AP 1502 described in FIG. 15. The target AP may be an embodiment of AP 1504 described in FIG. 15.

As shown in FIG. 18, action frame 1800 may include an action field 1802. In an embodiment, action field 1802 may indicate a request for or a response to an association transfer of a first STA from the initiating AP to the target AP. In an embodiment, action field 1802 may include a category subfield 1804 for indicating a STA association transfer. In an example, the action field 1802 may include an action details field 1806. In an embodiment, action field 1802 may further indicate a request for or a response to an association transfer of a second STA.

In an embodiment, the action details field 1806 may include a request/response flag subfield 1812, a STA ID subfield 1814, a target AP ID subfield 1816, a (re)association flag subfield 1818, a disassociation flag subfield 1820, a reason subfield 1822, an optional STA capability information subfield 1824, an optional target AP capability information subfield 1826, an optional STA operation information subfield 1828, and an optional target AP operation information subfield 1830.

In an embodiment, request/response flag subfield 1812 may indicate a request for or a response to an association transfer of STA(s) indicated in STA ID subfield 1814. In an implementation, request/response flag subfield 1812 may take a 0 or 1 value, where a value of 0 indicates a request for association transfer of STA(s) indicated in STA ID subfield 1814, and a value of 1 indicates a response to an association transfer of STAs indicated in STA ID subfield 1814.

In an embodiment, STA ID subfield 1814 may include identifiers of STA(s) being transferred to the target AP. For example, STA(s) being transferred to the target AP may comprise a first STA and a second STA. In an example, an identifier of the first STA may comprise an address of the first STA. In an example, an identifier of the second STA may comprise an address of the second STA.

In an embodiment, target AP ID subfield 1816 may include an identifier of the target AP of the STA association transfer. In an example, an identifier of the target AP may comprise an address of the target AP.

In an embodiment, (re)association flag subfield 1818 may indicate association or reassociation of the STA(s) indicated in STA ID subfield 1814 with the target AP indicated in target AP ID subfield 1816. In an implementation, (re)association flag subfield 1812 may take a 0 or 1 value, where a value of 0 indicates the association of the STA(s) with the target AP, and a value of 1 indicates the reassociation of the STA(s) with the target AP.

In an embodiment, disassociation flag subfield 1820 may indicate disassociation of the STA(s) indicated in STA ID subfield 1814. In an implementation, disassociation flag subfield 1820 may take a value of 0 or 1. In an example, disassociation flag subfield 1820 may take a value of 1 to indicate disassociation of the STA(s) indicated in STA ID subfield 1814. In an example, disassociation flag subfield 1820 may take a value of 1 when (re)association flag subfield 1818 indicates association of the STA(s) indicated in STA ID subfield 1814. In an example, disassociation flag subfield 1820 may take a value of 0 to indicate disassociation is not being signaled. In an example, disassociation flag subfield 1820 may take a value of 0 when (re)association flag subfield 1818 indicates reassociation of the STA(s) indicated in STA ID subfield 1814.

In an embodiment, reason subfield 1822 may indicate a reason for association transfer of the STA(s) indicated in STA ID subfield 1814. In an example, the reason subfield 1822 may comprise a reason code. In an example, the reason code may indicate that an initiating AP is scheduled to enter a power save mode. For example, the power save mode may comprise a doze state, a low power consumption state, or a power off sate.

In an embodiment, optional STA capability information subfield 1824 may comprise the capability information of the STA(s) indicated in STA ID subfield 1814. In an example, STA capability information subfield 1824 may comprise an indication of support by STA(s) indicated in STA ID subfield 1814 of the STA association transfer capability. In an example, optional STA capability information subfield 1824 may be present when request/response flag subfield 1812 indicates a request for association transfer of the STA(s) indicated in STA ID subfield 1814. In an example, optional STA capability information subfield 1824 may be reserved when request/response flag subfield 1812 indicates a response to an association transfer of the STA(s) indicated in STA ID subfield 1814.

In an embodiment, optional target AP capability information subfield 1826 may comprise the capability information of the target AP indicated in target AP ID subfield 1816. In an example, target AP capability information subfield 1826 may comprise an indication of support by the target AP indicated in target AP ID subfield 1816 of the STA association transfer capability. In an example, optional target AP capability information subfield 1826 may be present when request/response flag subfield 1812 indicates a response to an association transfer of the STA(s) indicated in STA ID subfield 1814. In an example, optional target AP capability information subfield 1826 may be reserved when request/response flag subfield 1812 indicates a request for association transfer of the STA(s) indicated in STA ID subfield 1814.

In an embodiment, optional STA operation information subfield 1828 may comprise operation information of the STA(s) indicated in STA ID subfield 1814. In an example, STA operation information subfield 1828 may indicate a power management mode of STA(s) indicated in STA ID subfield 1814. In an example, STA operation information subfield 1828 may comprise a link management information of STA(s) indicated in STA ID subfield 1814. In an example, optional STA operation information subfield 1828 may be present when request/response flag subfield 1812 indicates a request for an association transfer of the STA(s) indicated in STA ID subfield 1814. In an example, optional STA operation information subfield 1828 may be reserved when request/response flag subfield 1812 indicates a response to an association transfer of the STA(s) indicated in STA ID subfield 1814.

In an embodiment, optional target AP operation information subfield 1830 may comprise operation information of the target AP indicated in target AP ID subfield 1816. For example, target AP operation information subfield 1830 may indicate a power management mode of the target AP, a link management information of the target AP, MCS information, NSS set information, channel width information and/or channel center frequency information, etc. In an example, optional target AP operation information subfield 1830 may be present when request/response flag subfield 1812 indicates a response to an association transfer of the STA(s) indicated in STA ID subfield 1814. In an example, optional target AP operation information subfield 1830 may be reserved when request/response flag subfield 1812 indicates a request for an association transfer of the STA(s) indicated in STA ID subfield 1814.

As would be understood by a person of skill in the art based on the teachings herein, the embodiments as described by the above examples may be readily extended to cases including more than two STAs.

As would be understood by a person of skill in the art based on the teachings herein, the embodiments as described by the above examples may be readily extended to cases including more than two APs.

As would be understood by a person of skill in the art based on the teachings herein, the embodiments as described by the above examples may be readily extended to scenarios in which any of the APs or any of the STAs may comprise a MLD, comprising at least one affiliated AP or affiliated STA.

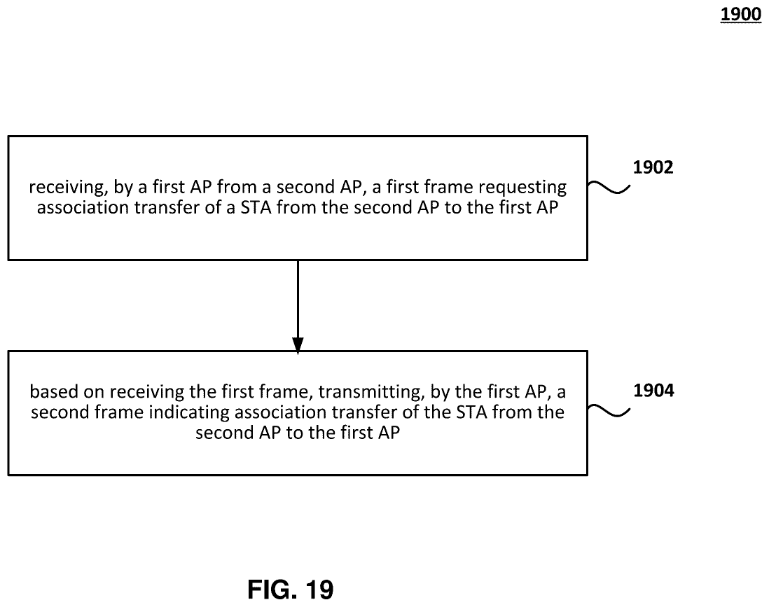

FIG. 19 illustrates an example process 1900 according to an embodiment. Example process 1900 is provided for the purpose of illustration only and is not limiting of embodiments. Process 1900 may be performed by a first AP.

As shown in FIG. 19, process 1900 begins in step 1902, which includes receiving, by the first AP from a second AP, a first frame requesting association transfer of a STA from the second AP to the first AP.

In an embodiment, the first AP belongs to a basic service set (BSS) and the second AP belongs to an overlapping basic service set (OBSS) relative to the BSS.

In an embodiment, the first AP and the second AP form a multi-AP group.

In an embodiment, the first frame indicates disassociation of the STA by the second AP. In an embodiment, the first frame comprises a disassociation frame.

In an embodiment, the first frame requests association or reassociation of the STA with the first AP. In an embodiment, the first frame comprises an association request frame or reassociation request frame.

In an embodiment, the first frame comprises an aggregate MAC protocol data unit (MPDU) comprising: a disassociation frame indicating disassociation of the STA by the second AP; and an association request frame requesting association of the STA with the first AP.

In an embodiment, the first frame indicates an identifier of the STA.

In an embodiment, the first frame comprises capability information of the STA.

In an embodiment, the first frame comprises operation information of the STA.

In an embodiment, the first frame indicates a reason for association transfer.

In step 1904, process 1900 includes, based on receiving the first frame, transmitting, by the first AP, a second frame indicating association transfer of the STA from the second AP to the first AP.

In an embodiment, the second frame further indicates association of the STA with the first AP. In an embodiment, the second frame comprises an association response frame.

In an embodiment, the second frame further indicates disassociation of the STA by the second AP. In an embodiment, the second frame comprises a disassociation frame.

In an embodiment, the second frame further indicates reassociation of the STA with the first AP. In an embodiment, the second frame comprises a reassociation response frame.

In an embodiment, the second frame indicates capability information of the first AP.

In an embodiment, the second frame indicates operation information of the first AP.

In an embodiment, process 1900 may further comprise transmitting, by the first AP to the second AP, an acknowledgment frame in response to the first frame.

In an embodiment, the first frame or the second frame comprises a management frame. In an embodiment, the management frame comprises a field or an element indicating the association transfer of the STA from the second AP to the first AP.

In an embodiment, the first frame further requests association transfer of a second STA from the second AP to the first AP.

In an embodiment, process 1900 may further comprise receiving, by the first AP from the second AP, a first indication of support by the second AP of a station association transfer capability; and transmitting, by the first AP to the second AP, a second indication of support by the first AP of the station association transfer capability.

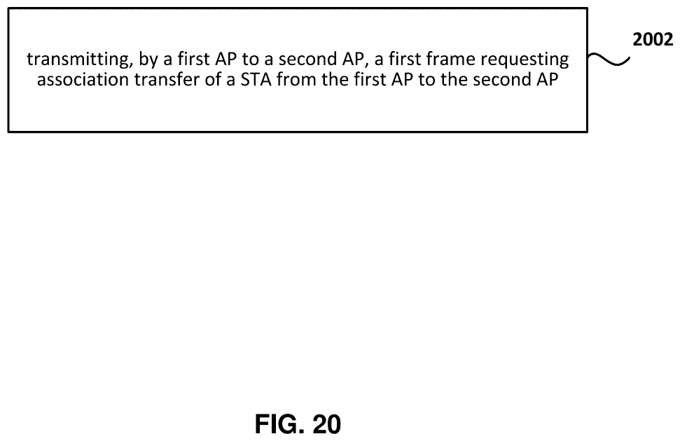

FIG. 20 illustrates an example process 2000 according to an embodiment. Example process 2000 is provided for the purpose of illustration only and is not limiting of embodiments. Process 2000 may be performed by a first AP.

As shown in FIG. 20, process 2000 begins in step 2002, which includes transmitting, by the first AP to a second AP, a first frame requesting association transfer of a STA from the first AP to the second AP.

In an embodiment, the first AP belongs to a basic service set (BSS) and the second AP belongs to an overlapping basic service set (OBSS) relative to the BSS.

In an embodiment, the first AP and the second AP form a multi-AP group.

In an embodiment, the first frame indicates disassociation of the STA by the first AP. In an embodiment, the first frame comprises a disassociation frame.

In an embodiment, the first frame requests association or reassociation of the STA with the second AP. In an embodiment, the first frame comprises an association request frame or reassociation request frame.

In an embodiment, the first frame comprises an aggregate MAC protocol data unit (MPDU) comprising: a disassociation frame indicating disassociation of the STA by the first AP; and an association request frame requesting association of the STA with the second AP.

In an embodiment, the first frame indicates an identifier of the STA.

In an embodiment, the first frame comprises capability information of the STA.

In an embodiment, the first frame comprises operation information of the STA.

In an embodiment, the first frame indicates a reason for association transfer.

In an embodiment, process 2000 may further comprise receiving, by the first AP from the second AP, an acknowledgment frame in response to the first frame.

In an embodiment, process 2000 may further comprise receiving, by the first AP from the second AP, a second frame.

In an embodiment, the second frame indicates association transfer of the STA from the first AP to the second AP.

In an embodiment, the second frame further indicates association of the STA with the second AP.

In an embodiment, the second frame further indicates reassociation of the STA with the second AP.

In an embodiment, the first frame or the second frame comprises a management frame. In an embodiment, the management frame comprises a field or an element indicating the association transfer of the STA from the first AP to the second AP.

In an embodiment, the first frame further requests association transfer of a second STA from the first AP to the second AP.

In an embodiment, process 2000 may further comprise transmitting, by the first AP to the second AP, a first indication of support by the first AP of a station association transfer capability; and receiving, by the first AP from the second AP, a second indication of support by the second AP of the station association transfer capability.

In an embodiment, process 2000 may further comprise transmitting, by the STA to a first AP, an association request frame; and receiving, by the STA from the first AP, an association response frame indicating association of the STA with the first AP.

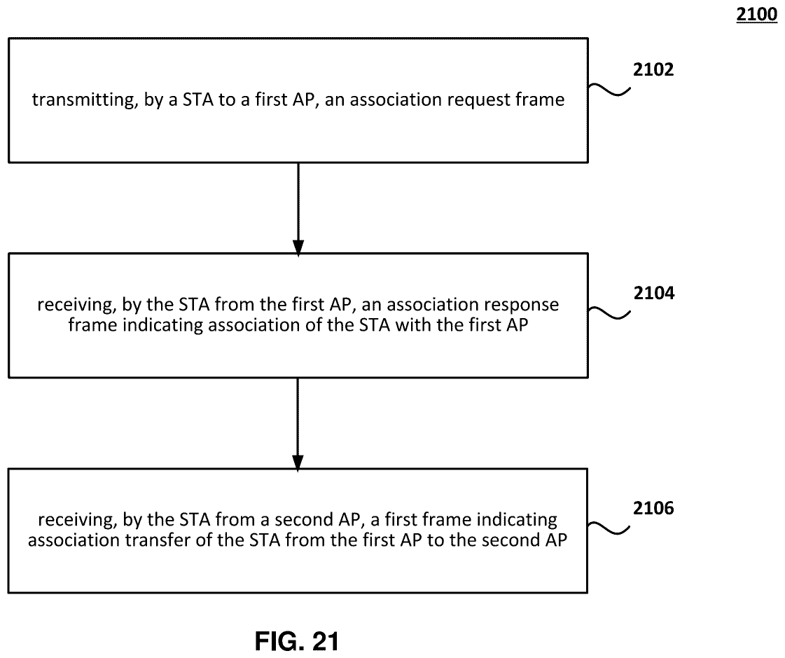

FIG. 21 illustrates an example process 2100 according to an embodiment. Example process 2100 is provided for the purpose of illustration only and is not limiting of embodiments. Process 2100 may be performed by a STA.

As shown in FIG. 21, process 2100 begins in step 2102, which includes transmitting, by a STA to a first AP, an association request frame.

In an embodiment, the association request frame comprises a first indication of support by the STA of a station association transfer capability.

In step 2104, process 2100 includes, receiving, by the STA from the first AP, an association response frame indicating association of the STA with the first AP.

In an embodiment, the association response frame comprises a second indication of support by the first AP of the station association transfer capability.

In step 2106, process 2100 includes, receiving, by the STA from a second AP, a first frame indicating association transfer of the STA from the first AP to the second AP.

In an embodiment, receiving the first frame indicating the association transfer of the STA from the first AP to the second AP comprises receiving the frame without transmitting an association request or a reassociation request from the STA to the second AP.

In an embodiment, the first frame is not in response to an association request or a reassociation request from the STA to the second AP.

In an embodiment, the first frame further indicates association of the STA with the second AP. In an embodiment, the first frame comprises an association response frame.

In an embodiment, the first frame further indicates disassociation of the STA by the first AP. In an embodiment, the first frame comprises a disassociation frame.

In an embodiment, the first frame further indicates reassociation of the STA with the second AP. In an embodiment, the first frame comprises a reassociation response frame.

In an embodiment, the first frame indicates capability information of the second AP.

In an embodiment, the first frame indicates operation information of the second AP.

In an embodiment, process 2100 may further comprise receiving, by the STA from the first AP, a second frame requesting the first frame.

In an embodiment, the second frame indicates disassociation of the STA by the first AP. In an embodiment, the second frame comprises a disassociation frame.

In an embodiment, the second frame requests association or reassociation of the STA with the second AP.

In an embodiment, the second frame comprises an aggregate MAC protocol data unit (MPDU) comprising: a disassociation frame indicating disassociation of the STA by the first AP; and an association request frame requesting association of the STA with the second AP.

In an embodiment, the second frame indicates an identifier of the STA.

In an embodiment, the second frame indicates a reason for association transfer.

In an embodiment, the first frame or the second frame comprises a management frame. In an embodiment, the management frame comprises a field or an element indicating the association transfer of the STA from the first AP to the second AP.

In an embodiment, the first AP belongs to a basic service set (BSS) and the second AP belongs to an overlapping basic service set (OBSS) relative to the BSS.

In an embodiment, the first AP and the second AP form a multi-AP group.

What is claimed is:

1. A method comprising:
transmitting, by a station (STA) to a first access point (AP), an association request frame;
receiving, by the STA from the first AP, an association response frame indicating association of the STA with the first AP; and
receiving, by the STA from a second AP and without transmitting an association request or a reassociation request from the STA to the second AP, a first frame indicating association transfer of the STA from the first AP to the second AP.

2. The method of claim 1, wherein the first frame further indicates association of the STA with the second AP and disassociation of the STA by the first AP.

3. The method of claim 1, wherein the first frame further indicates reassociation of the STA with the second AP.

4. The method of claim 1, further comprising receiving, by the STA from the first AP, a second frame requesting the first frame.

5. The method of claim 4, wherein the second frame indicates an identifier of the STA.

6. The method of claim 4, wherein the second frame indicates a reason for association transfer.

7. The method of claim 1, wherein the first frame comprises a management frame, and wherein the management frame comprises a field or an element indicating the association transfer of the STA from the first AP to the second AP.

8. The method of claim 1, wherein the first AP belongs to a basic service set (BSS) and the second AP belongs to an overlapping basic service set (OBSS) relative to the BSS.

9. The method of claim 1, wherein the first AP and the second AP form a multi-AP group.

10. A station (STA) comprising:
one or more processors; and
memory storing instructions that, when executed by the one or more processors, cause the STA to:
transmit to a first access point (AP) an association request frame;
receive from the first AP an association response frame indicating association of the STA with the first AP; and
receive from a second AP, without transmitting an association request or a reassociation request from the STA to the second AP, a first frame indicating association transfer of the STA from the first AP to the second AP.

11. The STA of claim 10, wherein the first frame further indicates association of the STA with the second AP and disassociation of the STA by the first AP.

12. The STA of claim 10, wherein the first frame further indicates reassociation of the STA with the second AP.

13. The STA of claim 10, further comprising receiving, by the STA from the first AP, a second frame requesting the first frame.

14. The STA of claim 13, wherein the second frame indicates an identifier of the STA.

15. The STA of claim 13, wherein the second frame indicates a reason for association transfer.

16. The STA of claim 10, wherein the first frame comprises a management frame, and wherein the management frame comprises a field or an element indicating the association transfer of the STA from the first AP to the second AP.

17. The STA of claim 10, wherein the first AP belongs to a basic service set (BSS) and the second AP belongs to an overlapping basic service set (OBSS) relative to the BSS.

18. The STA of claim 10, wherein the first AP and the second AP form a multi-AP group.

19. A non-transitory computer-readable medium comprising instructions that, when executed by one or more processors of a station (STA), cause the STA to:
transmit to a first access point (AP) an association request frame;
receive from the first AP an association response frame indicating association of the STA with the first AP; and
receive from a second AP, without transmitting an association request or a reassociation request from the STA to the second AP, a first frame indicating association transfer of the STA from the first AP to the second AP.

20. The non-transitory computer-readable medium of claim 19, wherein the first frame further indicates association of the STA with the second AP and disassociation of the STA by the first AP.
